(19) United States
(12) Patent Application Publication
(10) Pub. No.: US 2025/0071751 A1
(43) Pub. Date: Feb. 27, 2025

(54) UE SUGGESTED UPLINK RESOURCE ALLOCATION

(71) Applicant: QUALCOMM Incorporated, San Diego, CA (US)

(72) Inventors: Mickael MONDET, Louannec (FR); Prashanth Haridas HANDE, San Diego, CA (US); Diana MAAMARI, San Diego, CA (US); Hyun Yong LEE, San Diego, CA (US)

(21) Appl. No.: 18/455,559

(22) Filed: Aug. 24, 2023

(51) Int. Cl. H04W 72/1268; H04W 72/21; H04W 72/51

(52) U.S. Cl. CPC H04W 72/1268; H04W 72/21; H04W 72/51

(57) ABSTRACT

A UE transmits information to a network node indicating at least one of an aggregation capability or payload pattern information for multiple uplink data flows of the UE and receives a grant of uplink resources for the multiple uplink data flows based on the information transmitted to the network node. A network node obtains information from a UE, the information indicating at least one of an aggregation capability or payload pattern information for multiple uplink data flows of the UE; and provides a grant of uplink resources for the multiple uplink data flows based on the information transmitted to the network node.

### TECHNICAL FIELD

The present disclosure relates generally to communication systems, and more particularly, to wireless communication including the allocation of uplink resources.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may be configured to transmit information to a network node indicating at least one of an aggregation capability or payload pattern information for multiple uplink data flows of the UE; and receive a grant of uplink resources for the multiple uplink data flows based on the information transmitted to the network node.

In an aspect of the disclosure, a method, a computer-readable medium, and an apparatus are provided for wireless communication at a network node. The apparatus may be configured to obtain information from a UE, the information indicating at least one of an aggregation capability or payload pattern information for multiple uplink data flows of the UE; and provide a grant of uplink resources for the multiple uplink data flows based on the information transmitted to the network node.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example aspects of XR communication

FIG. 5 is a diagram illustrating example aspects of XR communication.

FIG. 6A illustrates an example timeline showing the latency between data arrival in an empty buffer until data transmission when the UE waits to receive a dynamic grant of uplink resources.

FIG. 6B illustrates an example timeline showing the latency between the data arrival in the buffer to the transmission of the data in an uplink resource based on a configured grant.

FIG. 6C illustrates an example timeline in which the latency is shown between an arrival of first uplink data in an empty buffer to the transmission of the data after an SR and BSR.

FIG. 7A illustrates an example communication flow between a UE and a network including a configured grant for a data flow.

FIG. 7B illustrates examples of two data flows.

FIG. 8 illustrates an example communication flow between a UE and a network including multiple data flows.

FIG. 9 illustrates an example communication flow between a UE and a network including multiple data flows including aggregation of data transmission for the multiple flows.

FIG. 10 illustrates an example communication flow between a UE and a network that includes the aggregation of data from multiple data flows.

FIG. 11 illustrates an example time diagram showing example aspects that a UE may use to indicate timing information for an aggregated flow to the network.

FIG. 12 illustrates a time diagram 1200 showing an example bitmap for the dynamic indication.

FIG. 13 illustrates an example communication flow diagram between a UE and a network in which the network configures multiple TBSs for a configured grant to enable the UE to aggregate data of multiple flows in CG occasions.

FIG. 14 illustrates an example diagram showing resource allocation information that a UE may provide to a network.

FIG. 15 illustrates an example communication flow in which the UE may indicate suggested allocation pattern information for multiple data flows.

FIG. 16 illustrates an example resource diagram showing resource allocation information that a UE may provide to a network.

FIG. 17 illustrates an example resource diagram for which a UE indicates a grant type and/or size of data that will be available for transmission.

FIG. 18 illustrates an example resource diagram for semi-static reporting of a UE suggested resource allocation.

FIG. 19 illustrates an example in which a UE may transmit an override report to a base station to adjust a previous semi-static indication for resource allocation.

FIG. 20 is a flowchart of a method of wireless communication at a UE.

FIG. 21 is a flowchart of a method of wireless communication at a network node.

FIG. 22 is a diagram illustrating an example of a hardware implementation for an example apparatus and/or UE.

FIG. 23 is a diagram illustrating an example of a hardware implementation for an example network entity.

### DETAILED DESCRIPTION

Some wireless communication includes traffic flows having periodic amounts of uplink traffic. Some of the traffic may be associated with a lower latency. Latency may be reduced through the use of configured grants that enable the network to configure the UE with resources for uplink transmission that can be used as traffic arrives without waiting for a dynamic grant of uplink resources. In some aspects, greater efficiency may be achieved through the aggregation of data from one flow in a PUSCH transmission with another flow. Aspects presented herein enable a network to improve uplink resource allocation, which may reduce latency, reduce overhead, and/or allow for reduced power consumption at a UE. As presented herein, a UE provides the network (e.g., such as a base station) with information about capabilities for aggregation of data from a flow with data from another flow or about resource allocation preferences. The information enables the network to make an improved determination of resources to align with the traffic of the various flows at the UE. The base station may then provide the UE with one or more configured grants and/or dynamic grants of uplink resources for the UE to transmit the data.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

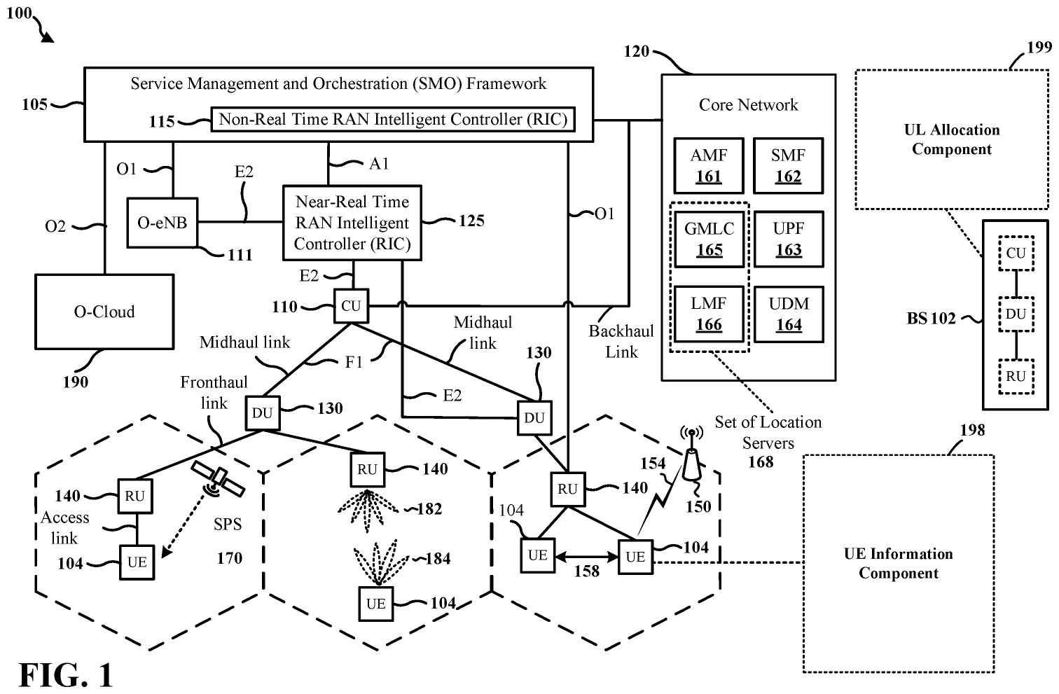

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a UE information component 198 that may be configured to transmit information to a network node indicating at least one of an aggregation capability or payload pattern information for multiple uplink data flows of the UE; and receive a grant of uplink resources for the multiple uplink data flows based on the information transmitted to the network node. In certain aspects, the base station 102 may have an uplink allocation component 199 that may be configured to obtain information from a UE, the information indicating at least one of an aggregation capability or payload pattern information for multiple uplink data flows of the UE; and provide a grant of uplink resources for the multiple uplink data flows based on the information transmitted to the network node.

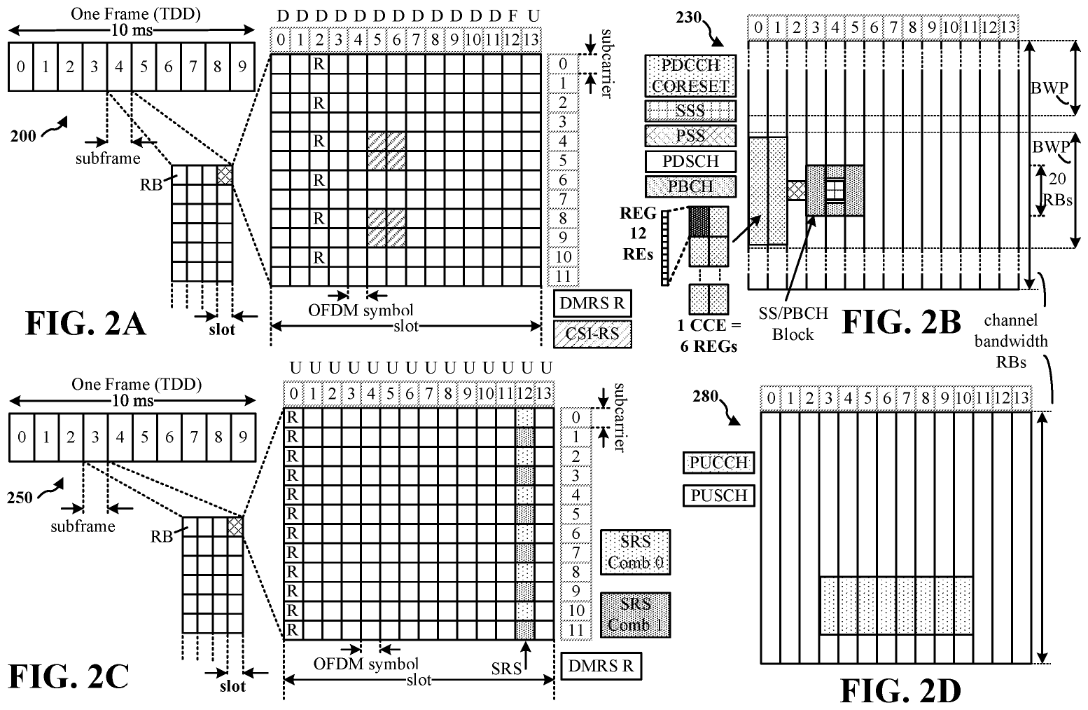

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

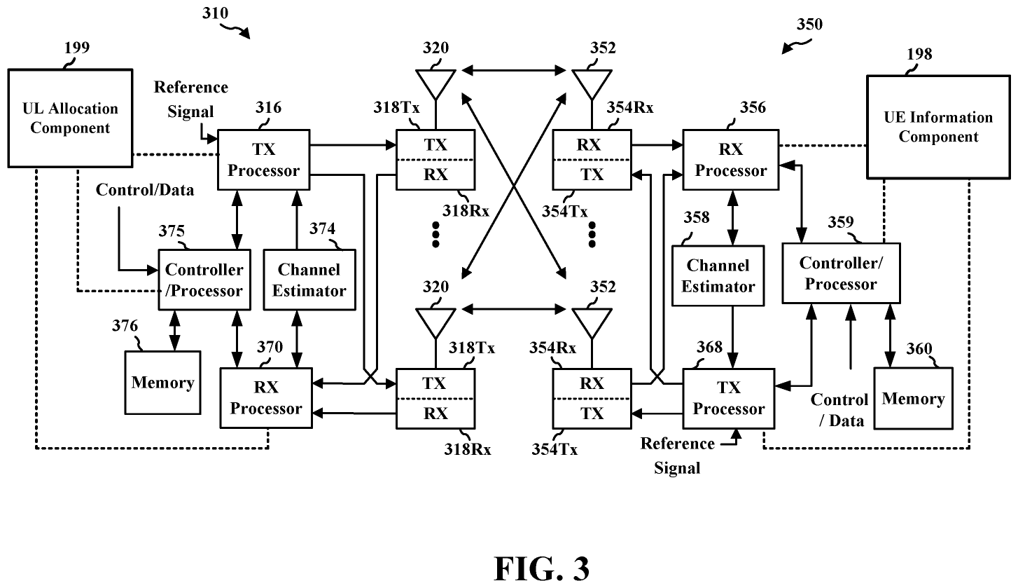

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the UE information component 198 of FIG. 1.

At least one of the TX processor 316, the RX processor 370, and the controller/processor 375 may be configured to perform aspects in connection with the uplink allocation component 199 of FIG. 1.

XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

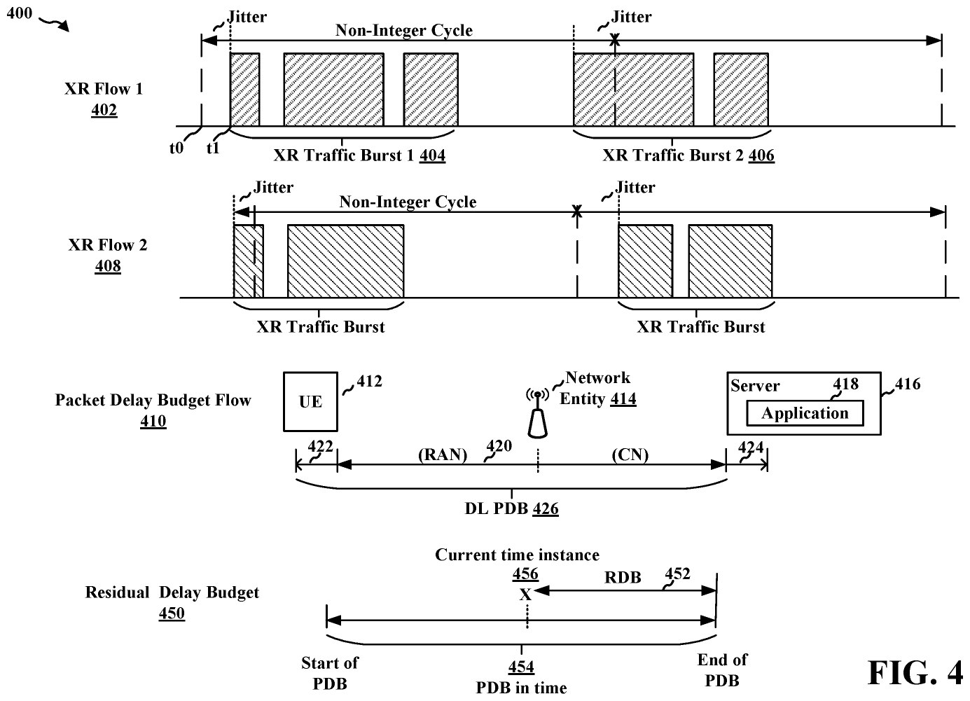

XR traffic may arrive in periodic traffic bursts (“XR traffic bursts”). An XR traffic burst may vary in a number of packets per burst and/or a size of each packet in the burst. FIG. 4 is a diagram 400 that illustrates a first XR flow 402 that includes a first XR traffic burst 404 and a second XR traffic burst 406. As illustrated in the diagram 400, the traffic bursts may include different numbers of packets, e.g., the first XR traffic burst 404 being shown with three packets (represented as rectangles in the diagram 400) and the second XR traffic burst 406 being shown with two packets. Furthermore, as illustrated in the diagram 400, the three packets in the first XR traffic burst 404 and the two packets in the second XR traffic burst 406 may vary in size, that is, packets within the first XR traffic burst 404 and the second XR traffic burst 406 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time t0, but the first packet of the first XR traffic burst 404 arrives at time t1.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In an example, the first XR flow 402 may include video data and the second XR flow 408 may include audio data for the video data. In another example, the first XR flow 402 may include intra-coded picture frames (I-frames) that include complete images and the second XR flow 408 may include predicted picture frames (P-frames) that include changes from a previous image.

As noted herein, XR traffic may have an associated e2e PDB. If a packet does not arrive within the e2e PDB, a UE (or a base station) may discard the packet. In an example, if a packet corresponding to a video frame of a video does not arrive at a UE within an e2e PDB, the UE may discard the packet, as the video has advanced beyond the frame. However, the RDB at the UE may be unaccounted for in consideration of discarding packets. An example time diagram 450 shows a length of time corresponding to a PDB 454. At a particular point in time 456, the residual delay budget 452 is the remaining portion of the PDB 454.

An XR traffic overall PDB may include a portion to allow for communication delay of data (e2e PDB) between a UE and a computing device, e.g., a server, hosting an application, e.g., for XR, and a portion for additional time after the communication delay before the data is discarded, e.g., residual delay (e.g., RDB). For instance, the diagram 400 includes a packet delay budget flow 410. Packet delay budget flow 410 illustrates a UE 412, a network entity 414, and a server 416 that hosts an application 418. In the illustrated aspect, a communication delay 420 is shown as including a RAN portion between the UE 502 and the network entity 414, as well as a CN portion between the network entity 414 and the server 416. The communication delay 420 may apply to both UL and DL communications. Additionally, a residual delay 422 is shown at the UE 412 for DL communications and a residual delay 424 is shown at the server 416 for UL communications. The communication delay 420 and the residual delay 422 may make up an overall PDB for DL XR communications, e.g., DL PDB 426. Likewise, the communication delay 420 and the residual delay 424 may make up an overall PDB for UL XR communications (not shown for illustrative clarity).

In general, XR traffic may be characterized by relatively high data rates and low latency. The latency in XR traffic may affect the user experience. For instance, XR traffic may have applications in eMBB and URLLC services.

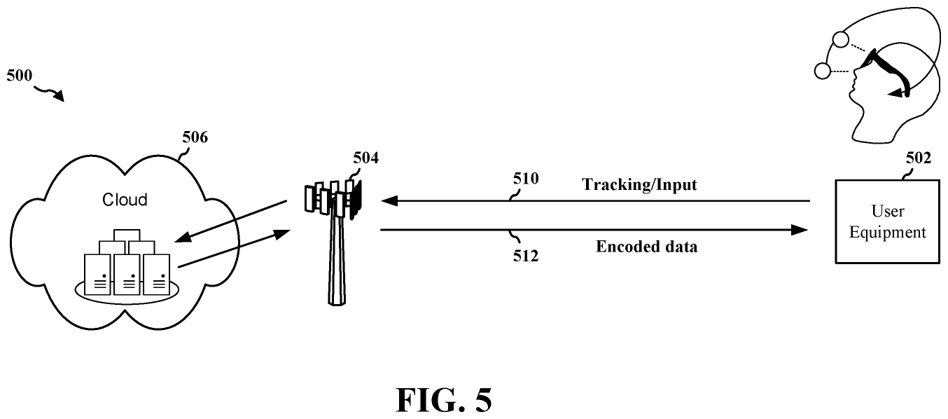

FIG. 5 is a diagram 500 illustrating an example of wireless communication that can included low latency traffic. The diagram 400 may include a user equipment (UE) 502, a base station 504, and a cloud server 506. In some aspects, the service provided to the UE 502 may be associated with a low latency traffic. In one example, the UE and the base station may be configured to provide an XR service or a cloud gaming service, and the associated traffic may be associated with a low latency. Accordingly, the uplink (UL) packet 510 may include input information such as a tracking information or user pose information for the XR service or inputs for the cloud gaming service. In some examples, the UL packet 510 may include data of 100 bytes every 2 ms (at 500 Hz). The cloud server 506 may receive the UL packet 510 and generate the downlink (DL) packet 512 based on the received UL packet 510. For example, the cloud server 506 may receive the UL packet 510 including the tracking/pose information for the XR service or inputs for the cloud gaming service, and generate the DL packet 512 based on the received UL packet 510 including the tracking/pose information for the XR service or inputs for the cloud gaming service.

The DL packet 512 may include an encoded data associated with the service provided to the UE. For example, the encoded data may include data of over 100 kilobytes at 45, 60, 75, or 90 frames per second (fps), i.e., every 22, 16, 13, or 11 milliseconds. The XR service or the cloud gaming service may be provided from a cloud server, and the DL packet 512 may include a quasi-periodic encoded video with burst frame every 1/fps seconds or two, possibly staggered, “eye-buffers” (or images) per frame every

$$\frac{1}{2 * fps}$$

seconds. In case the UE is provided with the cloud gaming service, the DL packet 512 may include a quasi-periodic encoded video with burst frame every 1/fps seconds. In case the UE is provided with the XR service, the DL packet 512 may include a quasi-periodic encoded video with separate images, staggered or simultaneously, for each eye per frame every

$$\frac{1}{2 * fps}$$

seconds.

In some aspects, the latency observed from the UE 502 may be associated with a round-trip time (RTT) between transmitting the UL packet 510 and receiving the DL packet 512. That is, the network latency experienced at the UE 502 may be determined based on a RTT between transmitting the UL packet 510 including the tracking/pose information for the XR service or the inputs for the cloud gaming service and receiving the DL packet including the encoded data associated with the service provided to the UE 502. In one example, the network latency at the UE 502 may be configured as the time between transmitting the UL packet 510 including the input information associated with the service provided to the UE 502 and receiving the encoded data associated with the service provided to the UE, the encoded data including a quasi-periodic encoded video with burst frame every 1/fps seconds or two, possibly staggered, “eye-buffers” (or images) per frame every

$$\frac{1}{2 * fps}$$

seconds. For example, the wireless network may be configured to have the RTT less than or equal to 20 ms to support the input information associated with the service provided to the UE 502.

Various aspects may be employed to provide power saving and/or capacity improvement for wireless communication, e.g., including XR traffic. Scheduling mechanisms such as semi-persistent scheduling (SPS) or a configured grant (CG) may be used to provide periodic resources for UL or DL communication that can be used without a dynamic grant of resources. Some types of wireless communication systems may employ dynamic grants for scheduling purposes to accommodate traffic (e.g., XR traffic). In a dynamic grant, a scheduler, e.g., such as a network entity, may use control signaling to allocate resources for transmission or reception at a UE (e.g., a grant of UL or DL resources). Dynamic grants may be flexible and can adopt to variations in traffic behavior. The CG may provide periodic or semi-static resources, e.g., that a UE can use for to transmit or receive communication without receiving individual grants. For example, a UE may receive a configured grant in an RRC configuration. The UE may then use the granted resources for transmission and/or reception without additional DCI. In some aspects, the UE may receive a MAC-CE activating a previously configured CG. For wireless communication that is based on a dynamic grant, the UE monitors for a PDCCH including a DCI that schedules the UE, e.g., allocates particular resources to the UE, to transmit or receive communication with a base station (e.g., instructions to receive data over a PDSCH). In some aspects, such as when a UE has data to transmit, the UE may transmit a scheduling request to a network entity to trigger the network entity to allocate resources for the transmission, such as in DCI. Various aspects also provide a UE to request for a dynamic grant (DG) of a resource for UL communication, e.g., reporting measured delay statistics. In contrast, the CG or SPS enables the UE to transmit uplink traffic or receive downlink traffic without DCI scheduling resources. The SPS or CG scheduling may be configured to accommodate the periodic traffic, multiple flows, jitter, latency, and reliability for the wireless traffic and may improve capacity and/or latency for such wireless communication. Traffic bursts, such as XR bursts by way of example, are periodic and may include some time jitter in the arrival.

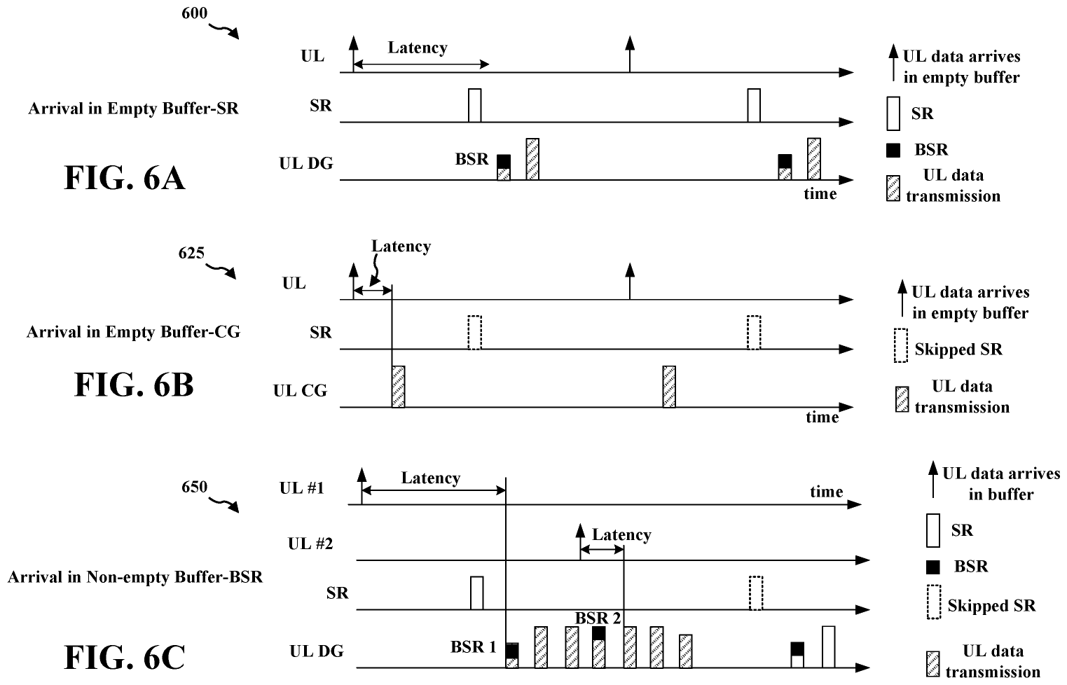

Various aspects may contribute to uplink latency. As an example, the latency may include a delay from an arrival of data in an empty buffer to the start of a transmission of the data. For example, if the UE receives a resource allocation in DCI, the latency may extend from the data arrival to the UE's transmission of a scheduling request (SR), transmission of a buffer status report (BSR) indicating the presence of the data, the reception of DCI allocating resources for the data transmission, up to the actual transmission of the data using the resources from the DCI. FIG. 6A illustrates an example timeline 600 showing the latency between data arrival in an empty buffer until data transmission when the UE waits to receive a dynamic grant (DG) of uplink resources, e.g., in DCI, following a scheduling request.

In some examples, the latency may extend from the data arrival in the buffer to the data transmission in a configured grant resource. FIG. 6B illustrates an example timeline 625 showing the latency between the data arrival in the buffer to the transmission of the data in an uplink resource based on a configured grant. As illustrated in FIG. 6B, the UE may skip an SR, because the UE has periodic or semi-persistent resources allocated for the uplink transmission.

In some aspects, the latency may extend from the data arrival in a non-empty buffer to the time that the base station is aware of the data and receives the data in an uplink transmission. FIG. 6C illustrates an example timeline 650 in which the latency is shown between an arrival of first uplink data (UL #1) in an empty buffer, to the transmission of the data after an SR and BSR. In some aspects, additional data may arrive in the buffer (e.g., UL #2), and the UE may use the resources allocated following the SR to provide an additional BSR for the UL #2, and may proceed to transmit the data (e.g., UL #2) without an SR.

In some aspects, the latency may further involve retransmission time for failed PDUs that are not received by the network. For example, the latency may be based on a HARQ round-trip time (RTT).

In some aspects, the latency may be longer when the data arrives in an empty buffer. The procedure including an SR, a BSR, and an uplink grant before the UE transmits the data adds time between data arrival and data transmission, which may reduce a user experience for low latency traffic. A configured grant may be more efficient for low latency periodic uplink traffic flows. The configured grants are helpful in reducing latency because the network allocates resources without a request from the UE, e.g., shown in the reduction in latency in FIG. 6B in comparison to FIG. 6A. For periodic traffic, the network may be aware, e.g., ahead of the uplink traffic arrival in the UE's buffer, of the frequency of the traffic arrival and the payload size of the traffic, e.g., how often and how much data arrives at the UE's buffer.

In some aspects, it may be helpful for the network to have information about non-periodic, such as quasi-periodic, uplink traffic so that the network can determined when and how many resources to allocate for the uplink data before it arrives at the UE's buffer. Although aspects may be described in connection with a DDDSU type slot pattern, FR-1, or numerology (u)=1, the concepts presented herein may also be applied for other types of slot patterns, other frequency ranges, and other numerology.

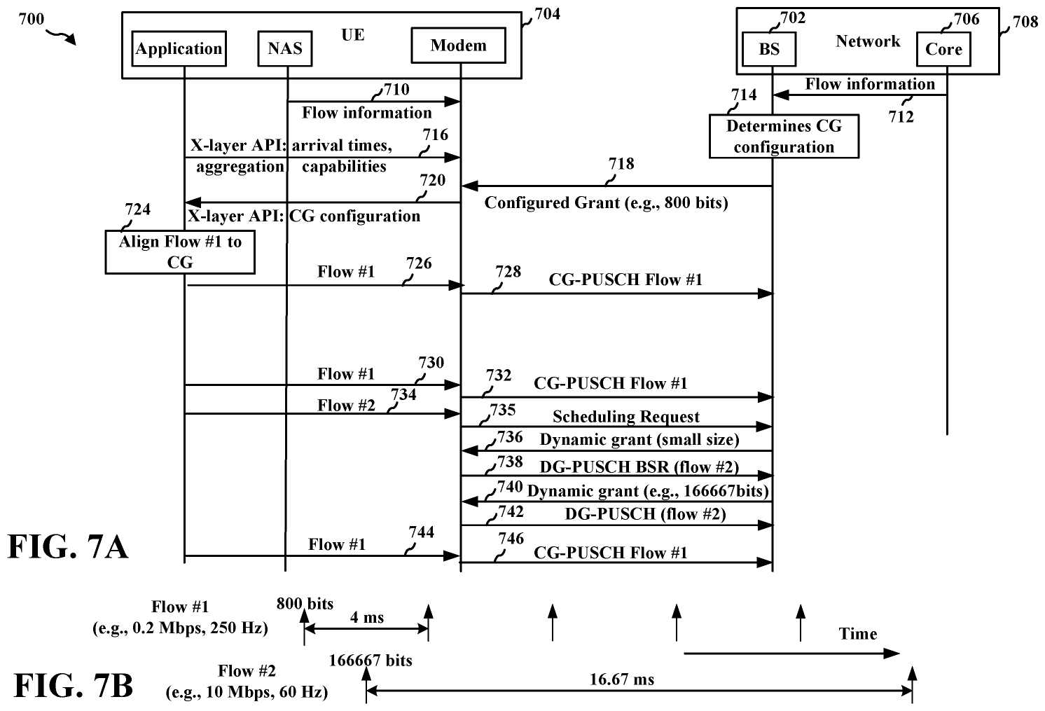

FIG. 7A illustrates an example communication flow 700 between a UE 704 and a network 708 that includes a base station 702 and a core network 706. FIG. 7A illustrates the UE transmitting multiple flows of uplink data traffic, e.g., including flow #1 and flow #2. FIG. 7B illustrates examples of two data flows. Flow #1 may include low latency data traffic. As an example, flow #1 may include pose information for an XR application. Flow #2 may include medium latency data that may be transmitted with more latency than flow #1. As an example, flow #2 may include uplink video having a longer period and higher throughput than flow #1. As illustrated at 718, the base station 702 may transmit a configured grant to the UE 704, e.g., a configured grant for uplink data flow #1. When data arrives for flow #1, e.g., at 726, 730, and 744, the UE may transmit the uplink data in a PUSCH transmission 728, 732, and 746 using the resources of the configured grant (e.g., which may be referred to as a CG-PUSCH transmission). The network may allocate resources in a configured grant of uplink resources for the UE without information provided by the UE. The network may obtain information about each uplink flow from the QoS characteristics for the traffic. As an example, the base station 702 may receive the flow information 712. From the QoS characteristics of the uplink flow, e.g., as received from the core network 706 at 712, the base station 702 may determine timing attributes such as a period, delivery time, and/or jitter for data flow #1. The base station 702 may determine payload attributes, such as payload size and/or payload variation, from the QoS characteristics for flow #1. The base station 702 may determine latency requirements for the flow #1 from the QoS characteristics. At 714, the base station 702 may determine when the uplink transmissions are to take place, e.g., which may be determined to optimize the flow requirements of flow #1, the resource utilization for flow #1, among other examples. The base station determines the CG configuration and transmits the CG configuration to the UE at 718. The configured grant may indicate a timing (e.g., period) and size (e.g., payload size) of the allocated resources. FIG. 7A illustrates that the X-layer API at the UE 704 may be used by the modem to notify the application of the configured grant configuration, at 720. The application may then align the uplink data flow for flow #1 (e.g., which may be a time sensitive flow) to the resources of the configured grant, e.g., at 724. FIG. 7A also illustrates that the non-access stratum (NAS) component of the UE may provide flow information 710 for one or more uplink data flows to the UE's modem, and the application at the UE may indicate arrival times and/or data aggregation capabilities to the mode at 716.

FIG. 7A illustrates that the UE may have more than one uplink data flow, e.g., flow #1 and flow #2. The CG may provide periodic or semi-persistent resources for flow #1. The UE may need to indicate the presence of uplink data for flow #2 to the network. FIG. 7A shows the arrival of data for flow #2 at 734, after which the UE 704 transmits a scheduling request 735 to the base station 702. The base station 702 responds with a dynamic grant 736 of resources that enables the UE to transmit a BSR about the data for flow #2 on a PUSCH (e.g., which may be referred to as a DG-PUSCH because it uses resources of the dynamic grant), at 738. At 740, the base station 702 responds to the BSR with a dynamic grant of uplink resources that is larger than the dynamic grant at 736. The UE transmits the data for flow #2 in a DG-PUSCH 742.

The communication flow in FIG. 7A involves the application aligning the arrival times of the latency sensitive data flow (e.g., flow #1) to the configured grant. In some situations, the application may not be able to align the data arrival with the resources of the configured grant, leading to added latency for the data flow. The added latency may reduce the user experience, for example. Less latency sensitive data flows may involve the transmission of an SR and BSR, e.g., as shown for flow #2. This involves added overhead for the SR, BSR, and dynamic grant transmissions, in addition to causing added latency in the transmission of flow #2. Additionally, there is information that affects the UE, such as power consumption, that cannot be accounted for based on scheduling policies. For example, the base station does not know the power consumption of the UE, (e.g., cannot determine it from the QoS information obtained at 712) and is not able to adapt uplink resource scheduling to address the UE's current power consumption experience.

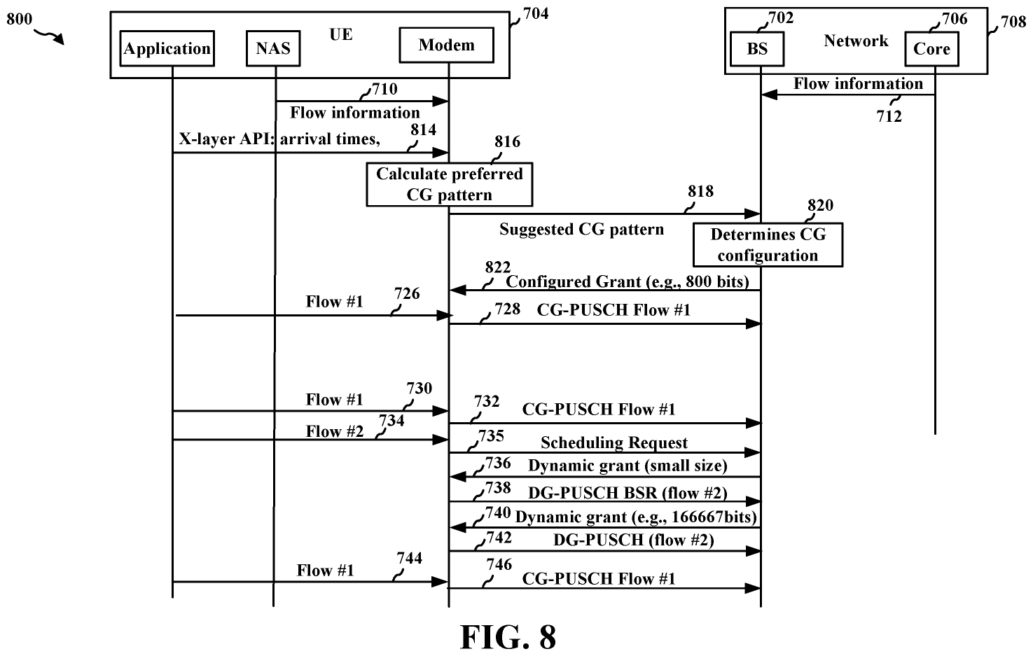

In some aspects, a UE may report a preference regarding a configured grant pattern to the network. FIG. 8 illustrates an example communication flow 800 between a UE 704 and the network 708. Aspects of FIG. 8 that have been described in connection with FIG. 7A are shown with the same reference number. In FIG. 8, the UE 704 indicates a configured grant pattern to the base station at 818, e.g., which may be referred to as a suggested CG pattern, a preferred CG pattern, among other examples. For example, the application may provide uplink data arrival times to the UE's modem at 814. The modem may receive the traffic information through the X-layer API or determine the traffic information with machine learning or artificial intelligence operations. The UE (e.g., the modem of the UE) may determine, at 816, a preferred CG pattern of uplink resources for the UE based on the arrival time information from the application. The determination may be based on a latency optimized CG pattern for the traffic, for example. The UE 704 may then transmit an indication of the determined CG pattern to the network at 818. The base station may use the indication of the CG pattern from the UE to determine the CG configuration for the UE, at 820. Then, the base station 702 may transmit the configured grant configuration to the UE at 822. The example, in FIG. 8 enables the network to align the resource allocation of the configured grant to the uplink traffic rather than the application at the UE attempting to align the uplink data traffic to the configured grant.

Although the example in FIG. 8 only shows the UE provided preferred configured grant information for a single uplink data flow, the concept may be similarly applied for multiple uplink data flows, and the UE may indicate one or more preferred configured grants for the multiple data flows.

Aspects presented herein enable more efficient allocation of uplink resources by having the UE provide the network with information about aggregation capabilities and/or payload pattern information that enables the network to provide a more targeted resource allocation based on the capabilities supported by the UE. The aspects presented herein help to minimize latency (e.g., reducing BSR for quasi-periodic flows, and helps to optimize resource allocation. Aspects help to enable the uplink activity at the UE to match the current UE circumstances and the uplink traffic of the UE. The aspects may help to reduce overhead while helping to meet the various latency requirements of traffic such as uplink XR traffic or metaverse traffic.

As an example, data bursts from flows with relaxed latency requirements (e.g., that allow for a longer latency time) may not be transmitted right away. In some aspects, the modem can aggregate data from such relaxed latency flows with data from other flows that have more strict latency requirement (e.g., that have a shorter latency time requirement). When data from aggregated data flows arrives in a buffer at the UE, the UE (e.g. modem of the UE) does not trigger a BSR, but instead buffers the data until the next granted resources (e.g., such as a configured grant resources for a more latency sensitive data flow). The UE then transmits the data from the relaxed latency data flow with the data of the lower latency data flow in the next granted resources. The aggregation of the data from different flows helps to reduce the number of SR and PUSCH transmissions from the UE and can enable longer periods of time when the UE may remain in a sleep mode (e.g., which may be referred to as longer sleeping gaps). The additional time that the UE can remain in the sleep mode decreases power consumption at the UE to provided added power savings.

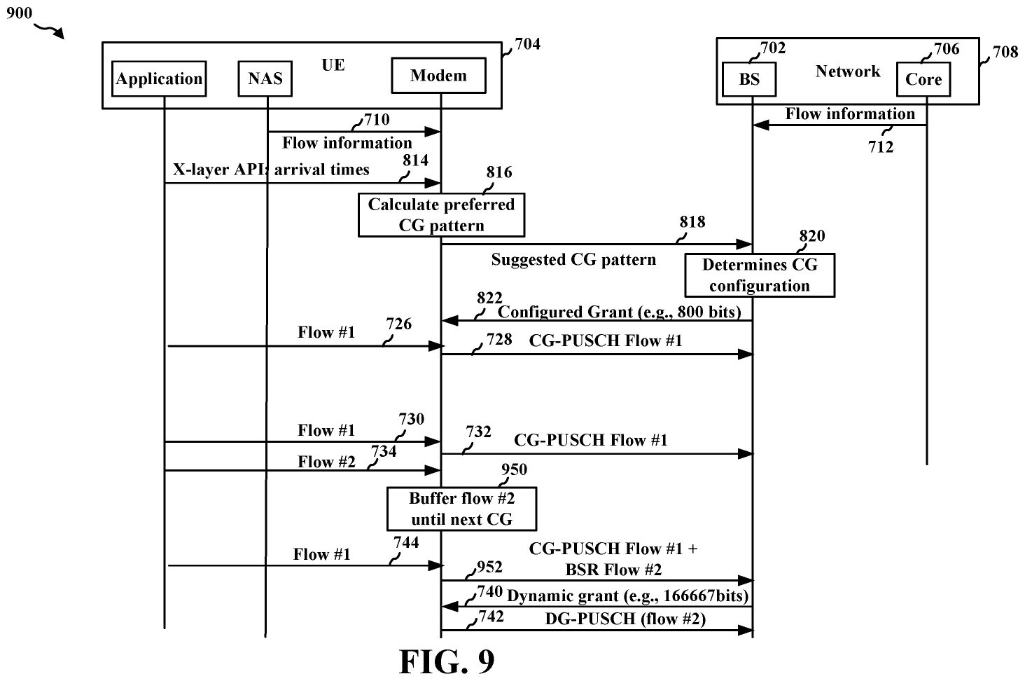

FIG. 9 illustrates an example communication flow 900 between a UE and a network that includes the aggregation of data from multiple data flows. Aspects of FIG. 9 that have been described in connection with FIG. 7A or FIG. 8 are shown with the same reference number. In FIG. 9, rather than sending an SR, as in FIG. 7A and FIG. 8, in response to the arrival of the data for flow #2 at 734, the UE buffers the data for flow #2, at 950, until the next uplink resource of the configured grant for flow #1. Then, at 952, the UE transmits both the CG-PUSCH with the data for flow #1 and the BSR for flow #2 to the base station 702. The base station responds to the BSR with the dynamic grant 740 described in connection with FIG. 7A, and the UE transmits the DG-PUSCH with the buffered data for flow #2, at 742.

The UE will still send a BSR for the aggregated flows, e.g., transmitted on the next granted resources. There is a second PUSCH in response to the BSR. In some aspects, the second PUSCH can be avoided if the network is otherwise aware of the aggregation by the UE.

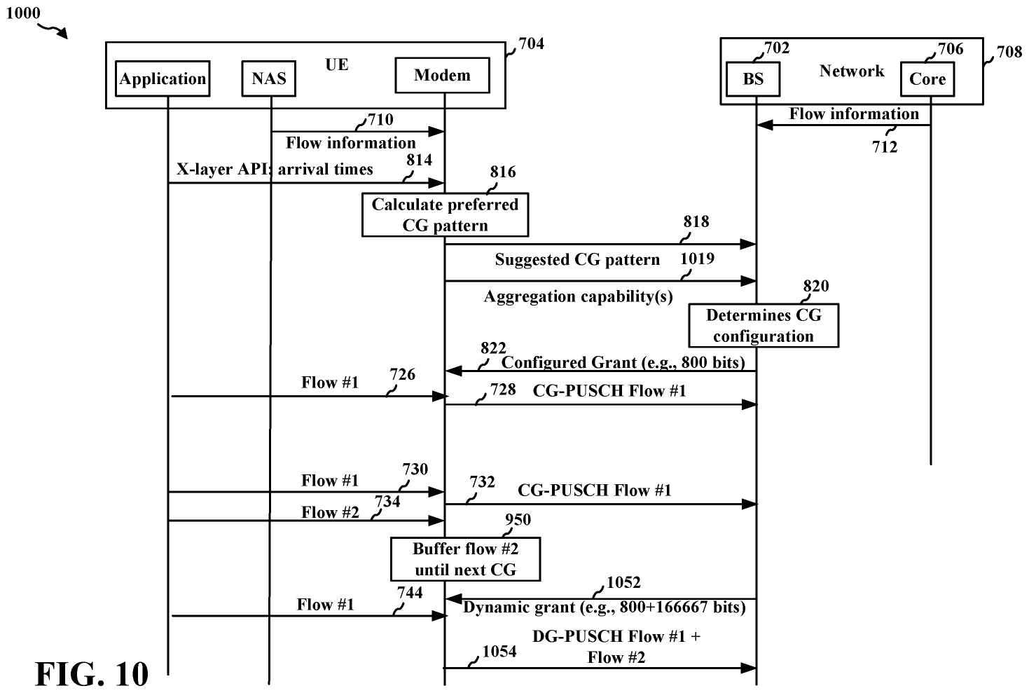

FIG. 10 illustrates an example communication flow 1000 between a UE and a network that includes the aggregation of data from multiple data flows. Aspects of FIG. 10 that have been described in connection with FIG. 7A, FIG. 8, or FIG. 9 are shown with the same reference number. In FIG. 10, in addition to transmitting an indication of the suggested CG pattern, at 818, the UE informs the network that the UE supports the aggregation of data from the multiple flows, at 1019. For example, the UE may transmit an indication that the UE supports one or more aggregation capabilities. The UE may also indicate when the data from multiple data flows can be aggregated.

By informing the base station that the UE supports the data aggregation, the UE may skip sending the BSR that the UE transmits at 952 in FIG. 9. Instead, the base station 702 may provide a dynamic grant, at 1052, with resources for both flow #1 and flow #2. Then, the UE transmits a PUSCH, at 1054, using the resources allocated through the dynamic grant, to transmit the flow #2 data (e.g., 734) and the flow #1 data (e.g., 744) in a single PUSCH transmission.

For periodic or quasi-periodic data flows with relaxed latency requirements, the UE can report their aggregation capabilities to the network. The network can use this capability information from the UE to allocate adequate resources for the aggregated data flows, e.g., without the BSR that is provided in FIG. 9. This enables an additional PUSCH transmission (e.g., 742) to be saved and enables a reduction in power consumption at the UE.

To support the aggregation of data flows for which the network has provided a configured grant, the network determines when a dynamic grant is to override a configured grant. For example, in FIG. 10, the dynamic grant 1052 overrides the occasion provided by the configured grant 822. The UE then uses the resources allocated in the dynamic grant to transmit the aggregation of the data from flow #1 and flow #2 rather than transmitting the data from flow #1 (e.g., 744) using the configured grant resources.

When indicating a preferred configured grant, the UE may indicate or suggest slots with CG-PUSCH occasions for uplink transmissions from the UE. In some aspects, the aggregation capability information that the UE provides to the network at 1019 may include, for each aggregated data flow, timing information, and expected payload size, a variation of a payload size, and/or jitter information. For example, the timing information may enable the network to determine when data from a particular data flow can be transmitted with data from a flow addressed by CG (e.g., a flow for which the network provides a configured grant of resources). The variation of the payload size and/or the jitter may be provided, e.g., by the application or may be learned at the UE.

In some aspects, the UE 704 may report or indicate semi-static aggregation capabilities to the base station 702 in an RRC message (e.g., as UE Assistance Information) or in a MAC-control element (MAC-CE).

The report is valid until a new one is transmitted.

In some aspects, the UE may indicate the expected payload size by transmitting an indication of an index that references a table. For example, the table may be a base station value table. For example, the base station may configure a set of payload size values in a table, and the UE may indicate a particular payload size using an index from the table. In some aspects, the table may be a defined table.

In some aspects, the UE may indicate semi-static aggregation capabilities to the network. As an example, the UE may report or indicate the timing information to the network as a period of an aggregated data flow and a system time of a first data burst. For example, the UE may indicate a first data burst with respect to a start of a frame with SFN=0, and the network may determine the slots of the CG pattern when the bursts can be transmitted.

In some aspects, the UE may report or indicate the timing information to the network, as shown at 1018, as a bitmap associated with the reported CG pattern, e.g., at 818. As an example, the bitmap length may be based on, or correspond to, the number of CG-PUSCH during the Least Common Multiple (LCM) of the periods of the aggregated and aggregating flows. Each bit in the bitmap may signals whether data from the aggregated flow will be available for transmission at the UE. As an example, a bit value of 0 may indicate that the aggregated data will not be available, and a bit value of 1 may indicate that the aggregated data will be available. The network can send Dynamic Grants for CG-PUSCH slots whose corresponding bit is set to 1, or otherwise indicated as having aggregated data available. Likewise, in other examples, the UE may use the opposite bit values to provide the indication, e.g., with 1 indicating data is not available and 0 indicating that data is available.

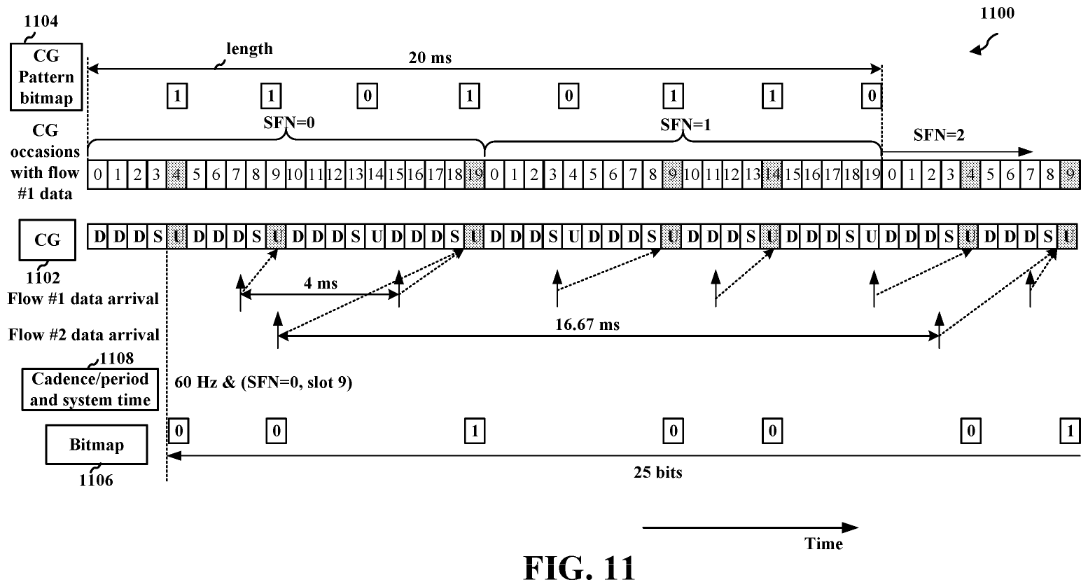

FIG. 11 illustrates an example time diagram 1100 showing example aspects that a UE may use to indicate timing information for an aggregated flow to the network. In this example, two flows are shown, e.g., flow #1 at 250 Hz and flow #2 at 60 Hz, e.g., similar to the example illustrated in FIG. 7B. As with the description in FIG. 7B, flow 1 may include 0.2 Mbps and may have 800 bits of data for transmission at each occasion. Flow #2 may have 10 Mbps and may have 166667 bits of data for transmission at each occasion. The network may provide the UE with a configured grant for flow #1. The UE may indicate to the network that it supports data aggregation from flow #2 to be transmitted together with data from flow #1. Flow #1 may be referred to as an aggregating flow, and flow #2 may be referred to as an aggregated flow. In this example, the bitmap may have a bitmap length based on LCM(4, (1000/60))=100 ms, and a Number of CG-PUSCH in 100 ms: 5*(100/20)=25.

In FIG. 11, resources for a CG 1102 are illustrated with the CG occasions shaded in which the UE has flow #1 data to transmit. The CG bitmap pattern 1104 illustrates a “1” when the UE has uplink data from flow #1 to transmit in an uplink occasion of the configured grant, and a “0” corresponds to occasions of the CG when the UE does not have uplink data from flow #1 to transmit. The bitmap 1106 illustrates a bit for each occasion of the CG when the UE has flow #1 to transmit, and the value of the bitmap 1106 indicates whether the UE has flow #2 data to aggregate at that occasion. The value of “0” in the bitmap 1106 indicates that the UE will not have flow #2 data to aggregate, and a value of “1” in the bitmap 1106 indicates that the UE will have flow #2 data to aggregate. The bitmap 1106 does not include bits for the CG occasions when the UE does not have flow #1 to transmit, e.g., the “0” bits from the CG bitmap (e.g., 1104).

FIG. 11 also illustrates an example of the UE indicating a period and system time of a first data burst of the aggregated flow (flow #2), at 1108. For example, the UE may indicate that the flow #2 supports aggregation and has a period of 60 Hz and has a first data burst at slot 9 of SFN 0.

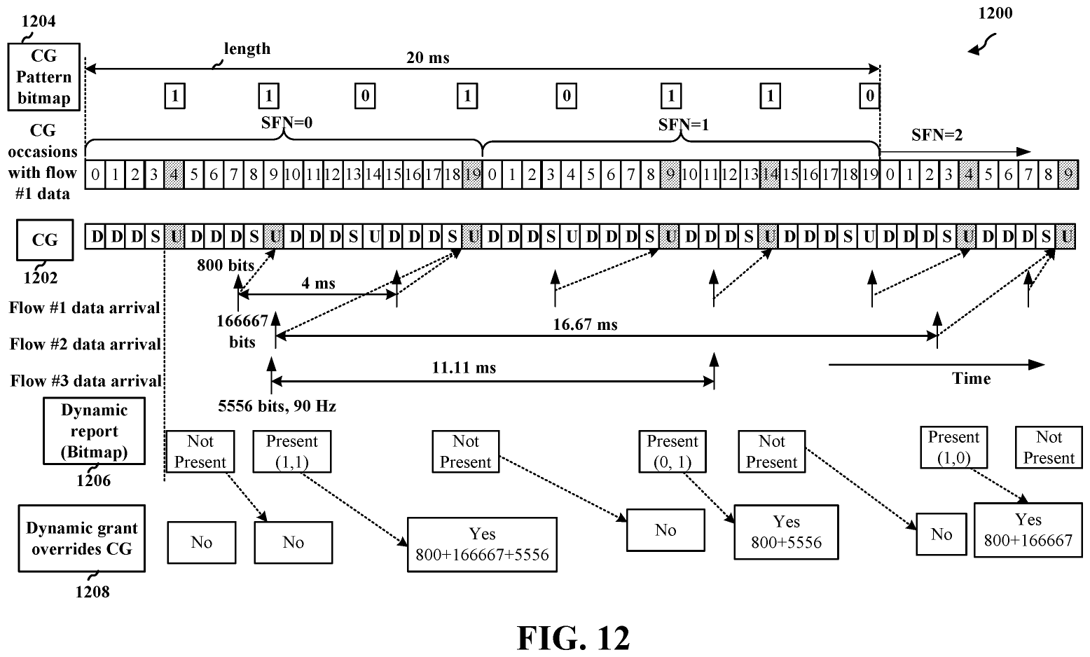

In some aspects, the UE may indicate dynamic aggregation capabilities to the network. As an example, the UE may transmit the aggregation capability information in resources of a CG or DG-PUSCH, the indication indicating whether data from one or more aggregated flows will be available for transmission on a next CG-PUSCH. This enables the UE to provide more dynamic aggregation information. In some aspects, the UE may report (or be assume to report) the payload size of each aggregated flow in a semi-static manner, e.g., as described in connection with FIG. 11. Each of multiple flows for the UE may be associated with an index. In a particular configured grant occasion, e.g., occasion N with N being an integer number, if data from at least one aggregated data flow (e.g., flow #2) will be available for transmission in the next CG occasion, e.g., occasion N+1, the UE may report the indexes of the at least one aggregated data flow as a bitmap. FIG. 12 illustrates a time diagram 1200 showing an example bitmap (e.g., 1206) for the dynamic indication. As with FIG. 11, a CG pattern, e.g., for flow #1 is shown at 1202. A CG bitmap pattern 1204 shows a “1” for CG occasions in which the UE has data for flow #1 to transmit, and a “0” indicates that the UE does not have data for flow #1 to transmit in the corresponding CG occasion. The dynamic indication (e.g., which may be a bitmap) indicates in each CG occasion whether there will be data for aggregation in a following CG occasion. As illustrated, there may be multiple traffic flows for aggregation, and the UE may indicate the flow for which there will be data to transmit (in aggregation) in the following CG occasion. An index may correspond to each data flow, and a value of “0” in the index indicates no data will be ready to transmit for that data flow, while a “1” indicates there will be data to transmit in aggregation in the next CG occasion. For example, the indication “(1,1)” indicates there will be data for aggregation for both flow #2 and flow #3, whereas “(0,1)” indicates that there will be data for flow #3 but not for flow #2, and “(1,0)” indicates that there will be data for flow #2 to aggregate but not for flow #3. The indication at row 1208 indicates for the particular CG occasion whether a dynamic grant will override the CG. As shown by the dashed lines, the overriding corresponds to the indication that the UE provides to the network in the prior CG occasion. The UE may transmit the indication of the dynamic aggregation capability in a MAC-CE or in UCI, for example.

In some aspects, there may be multiple transport block sizes (TBS) configured for the configured grants. If the UE provides semi-static reporting of aggregation information to the network, the network can know the burst size and the timing information of the aggregated bursts. Instead of overriding the configured grant by providing a dynamic grant, the network may configure the CG with multiple TBSs. In some examples, the multiple TBSs may include a main TBS, or primary TBS, and one or more secondary TBSs. A secondary TBS may apply to one or more particular CG occasions. Otherwise, the primary or main TBS may apply. For example, the UE may transmit uplink data using a particular, secondary TBS for the CG at one or more particular CG occasions, and may use the main or primary TBS for the CG at the other CG occasions. In some aspects, the CG occasions for which the secondary TBS will apply may be signaled, e.g., at 1019, in a similar manner to the indication of the timing information for the aggregation capabilities. For example, the UE may indicate the use of a secondary TBS in a dynamic indication, e.g., as described in connection with FIG. 12. The UE may indicate the planned use of the secondary TBS using period and a reference to a system time or using a bitmap, e.g., as described in connection with FIG. 11. In some aspects, the network may indicate to the UE the particular CG occasions in which the UE is to use the secondary TBS.

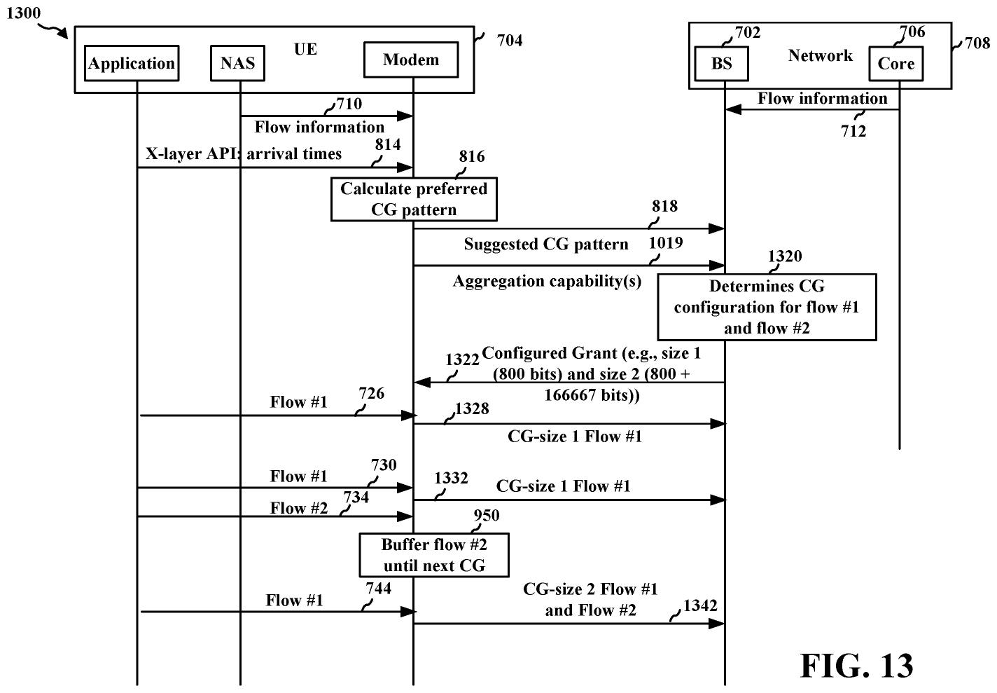

FIG. 13 illustrates an example communication flow diagram 1300 between a UE and a network in which the network configures multiple TBSs for a configured grant to enable the UE to aggregate data of multiple flows in CG occasions. The aspects of the communication flow that have been described in connection with FIGS. 7A, 8, 9, and 10 are show using the same reference numbers. In FIG. 10, the UE receives a CG with a single TBS (e.g., corresponding to the data payload of flow #1), and the network provides dynamic grants to enable the UE to transmit the flow #2 data in an aggregated manner with flow #1 data. In contrast to FIG. 10, in FIG. 13, the base station 702 determines a CG configuration at 1320 based on multiple flows, e.g., flow #1 and flow #2. For example, the BS may configure multiple TBSs based on combinations (e.g., aggregations) of various combinations of flows, e.g., in the configuration 1322. The UE may transmit uplink data (e.g., 726, 730) for flow #1 in a CG-PUSCH having a first size TBS (e.g., for 800 bits), as shown at 1328, and 1332. At 1342, the UE may transmit the aggregated uplink data for flow #1 (e.g., 744) and the data for flow #2 (e.g., 734) in a CG-PUSCH using a second TBS (e.g., 800+166667 bits) from the configured grant.

In some aspects, a UE may indication a set of allocation patterns, e.g., rather than reporting flow specific information. As an example, each pattern may be characterized by attributes such as a number of bits to be transmitted. The UE may report the allocation pattern information in a semi-static indication (e.g., in RRC signaling and/or a MAC-CE) or in a dynamic indication (e.g., in UCI or MAC-CE).

For example, the UE may determine when data from any periodic or quasi-periodic flow will be available for transmission, ahead of their actual delivery time by the application. The UE may determine the timing for the availability of the traffic based on an internal algorithm. In some aspects, fewer PUSCH may be favored to minimize the power consumption. The UE may determine the timing for the availability of the traffic based on information from an application, such as cadence information and/or throughput change information. The UE may determine the timing for the availability of the traffic based on interference mitigation. For example, the UE may avoid transmission at the same time as another device, such as avoiding timing for WiFi.

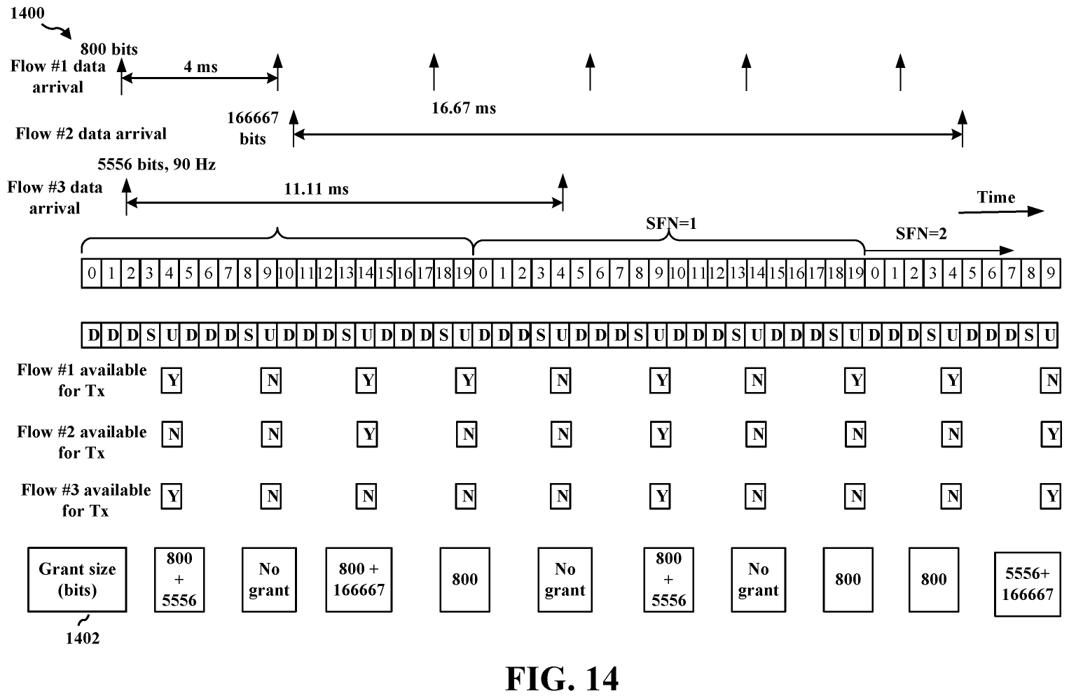

FIG. 14 illustrates an example 1400 of resource allocation information that a UE may provide to a network for traffic flow #1, flow #2, and flow #3. As illustrated in FIG. 14, the UE may indicate in a bitmap whether there will be traffic for the corresponding flow, and may indicate a bit size for an aggregated transmission of the available data, e.g., as shown at 1402.

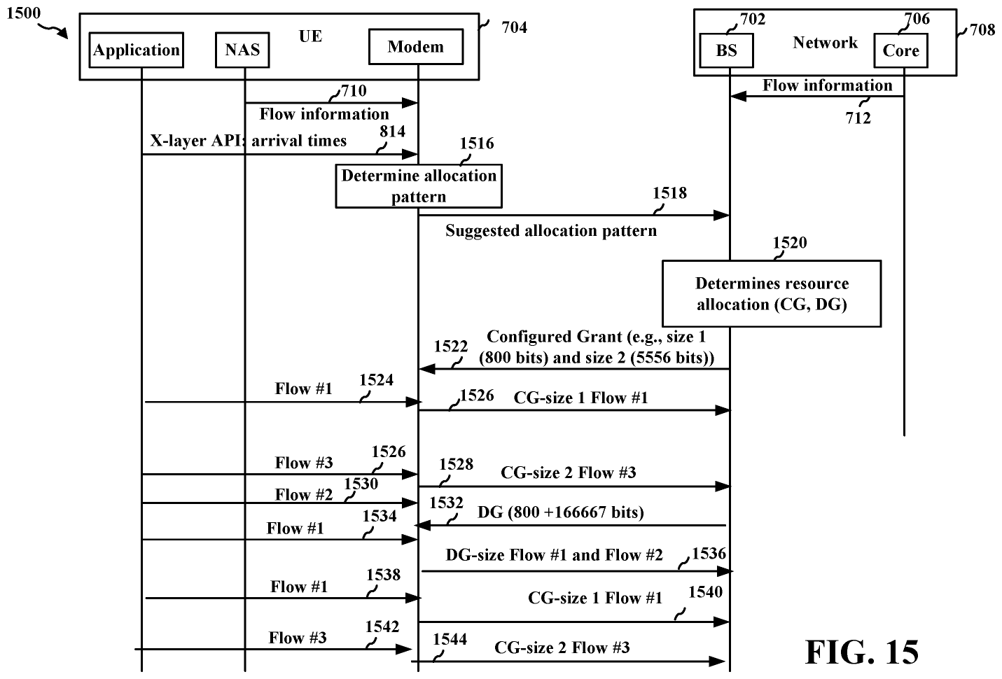

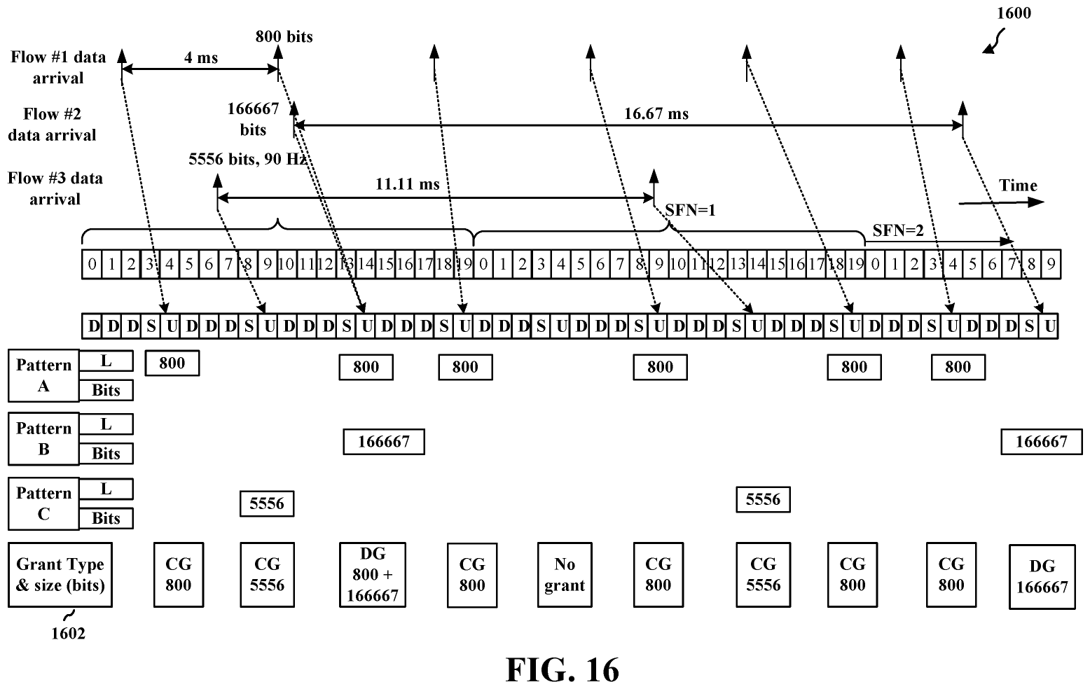

In some aspects, a UE may provide a semi-static report of resource allocation information (e.g., which may be referred to as a suggested resource allocation or a preferred resource allocation). As an example, at the beginning of the service, and/or when an update is needed, the UE may report one or more allocation patterns to the network. Each pattern may include a length (e.g., may be characterized based on a length). For each pattern, the UE may report when the data associated with the pattern will be available for transmission and the expected payload for the data to be transmitted. FIG. 15 illustrates an example communication flow 1500 in which the UE may indicate suggested allocation pattern information for multiple data flows. Aspects that have been described in connection with FIGS. 7 and/or 8 use the same reference numbers. At 1516, the UE determines an allocation pattern, e.g., for multiple flows, such as flow 1, 2, and 3 illustrated in FIG. 16. The UE transmits resource allocation information to the network at 1518, and the network uses the information to determine resource allocations for the UE, at 1520. For example, the base station 702 may determine one or more configured grants or dynamic grants for the UE based on the resource allocation information from the UE. At 1522, the base station provides the UE with a first configured grant having a first size (e.g., 800 bits) for flow #1, and a second configured grant having a second size (e.g., 5556 bits) for flow #3. At 1526 and 1540, the UE uses the configured grant with the first size to transmit a CG-PUSCH with the data for flow #1, e.g., 1524 and 1538. Similarly, at 1528 and 1544, the UE transmits a CG-PUSCH based on the second configured grant to transmit uplink data for flow #3 (e.g., 1526 and 1542). The base station 702 may provide the UE with a dynamic grant 1532 for an aggregation of the data from flow #2 at 1530 and flow #1 at 1534, which the UE may use to transmit a DG-PUSCH at 1536.

FIG. 16 illustrates an example resource diagram 1600 showing resource allocation information 1602 that a UE may provide to a network for traffic flow #1, flow #2, and flow #3. In FIG. 16, the UE reports three allocation patterns, e.g., pattern A for flow #1, pattern B for flow #2, and pattern C for flow #3. The example may be extended to any number of flows. In FIG. 16, flow #1 and flow #3 may be covered by a configured grant, as shown at 1522, 1526, and 1528 in FIG. 15, and the data for flow #2 may be addressed through a dynamic grant, e.g., as shown at 1532. The network may use the reported patterns to determine the resource allocation, e.g., whether to use a configured grant, a combination of configured grant(s) and dynamic grant(s), or a configured grant with multiple TBS, e.g., as described in connection with FIG. 10 or FIG. 13. FIG. 16 shows that the UE may indicate a type of resource allocation (e.g., CG or DG) and a size of resource allocation for each “U” slot based on any combination of data that will be available at that time. As shown in FIG. 16, each of the patterns may include a length (L) and a payload size in bits.

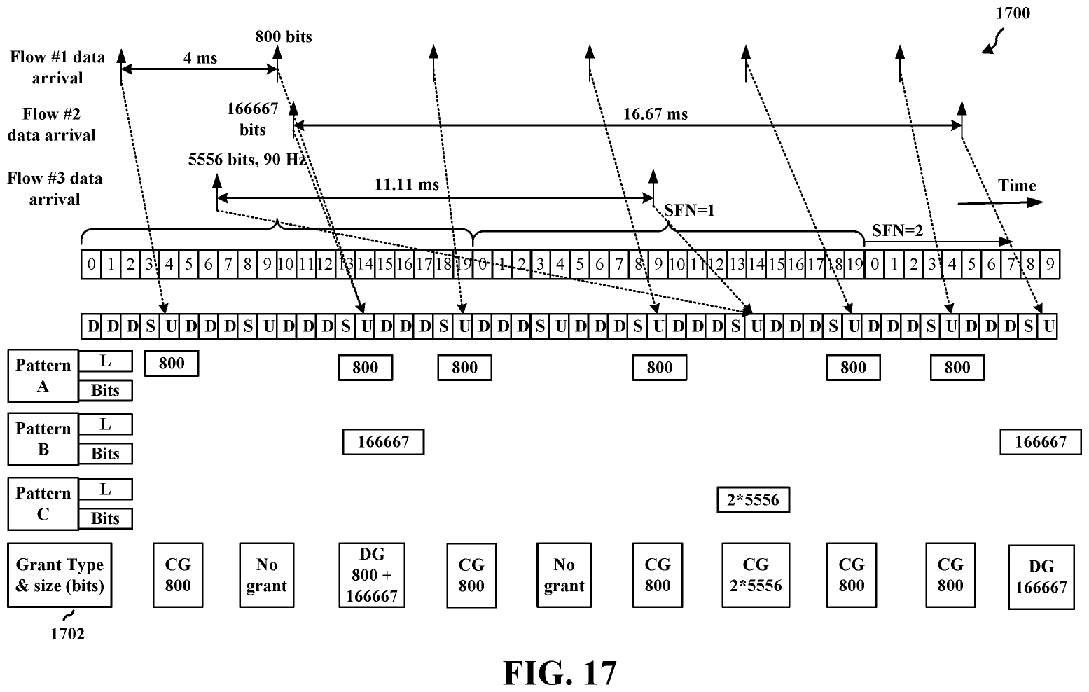

In some aspects, the network may not be informed of flow aggregation and burst aggregation inside the same flow, e.g., the flow aggregation and burst aggregation inside the same flow can be hidden from the network. The UE may report when and how much data will be available for transmission, ahead of the actual availability of the data, e.g., without being specific to the flow for which the data will be available. FIG. 17 illustrates an example resource diagram 1700 showing that the UE may indicate a grant type and/or size of data that will be available based on a combination of one or more data flows, e.g., without indicating the particular data flows. FIG. 17 illustrates patterns for flows #1, #2 and #3, and the UE reports 3 resources for Traffic Patterns #A, #B and #C. As shown at 1702, the UE may indicate a data size for aggregated bursts. For example, to minimize its power consumption, the UE may decide to reduce the number of PUSCH transmissions, and to aggregate data from flow #2 with data from flow #1 or #3. As well, in some aspects, the UE may determine to reduce PUSCH transmissions by aggregating multiple bursts from flow #3 before making them available for transmission, e.g., at the pattern C is illustrated as having 2*5556 bits for transmission following two data bursts from flow #3.

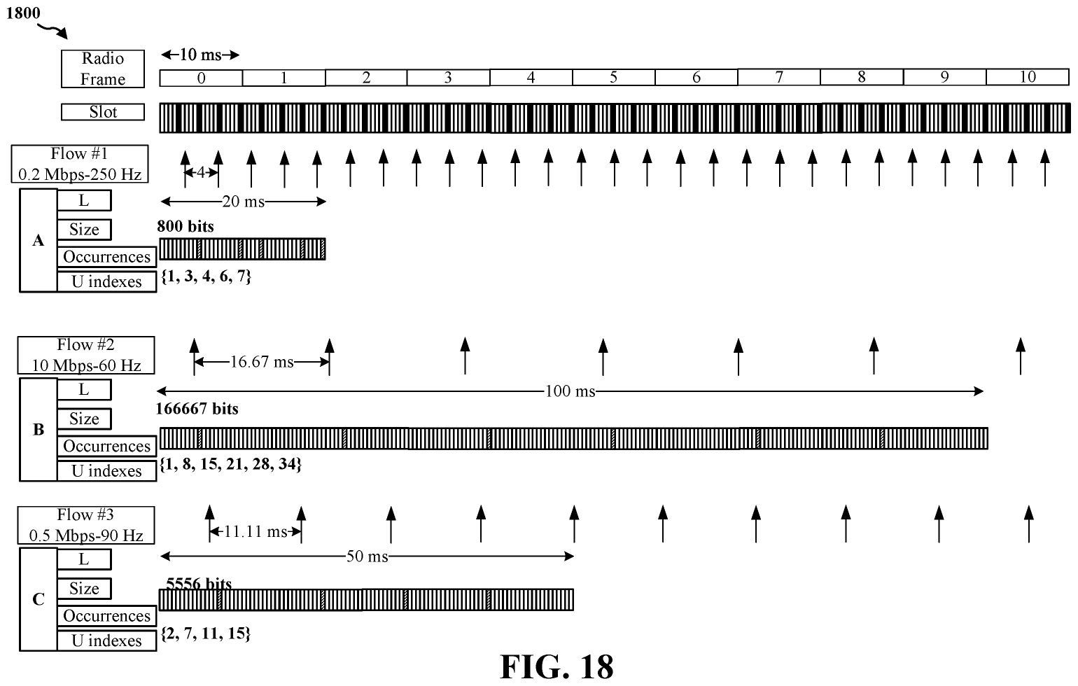

In some aspects, the UE may transmit a semi-static resource of suggested resource allocation information, the report including a list of allocation patterns. Each allocation pattern (e.g., as shown for example patterns A, B, and C) may be characterized by one or more of its period or length (L), a size of the payload that is available at each occurrence in the pattern, a list of occurrences in the pattern (e.g., uplink occurrences (slots) when the UE will have data to transmit, and each occurrence may signal the index of the uplink (U) slot inside the period when data is available for transmission. FIG. 18 illustrates an example resource diagram 1800 for semi-static reporting of a UE suggested resource allocation. In FIG. 18, the UE may provide information to the network about each of pattern A, pattern B, and/or pattern C to enable the network to allocate resources in a more efficient manner for the UE. In some aspects, the semi-static report may be transmitted as an RRC message and/or via an MAC-CE.

In some aspects, the UE may transmit an additional report to adjust or override the previously reported resource allocation information. In some aspects, the additional report may be referred to as an override report. As an example, after the UE transmits the semi-static resource allocation report, the UE may override the reported information if the UE knows that the next data burst won't match the reported information, e.g., if the data will be subject to jitter and/or a payload size variation. The UE may obtain the information from the application or may otherwise learn the information. In some aspects, the UE may override the previously reported semi-static information in a one-shot manner. In some aspects, the dynamic report (e.g., the overriding report) may include a list of overriding information. Each item of overriding information in the list may include any of an index of the traffic pattern that is overridden, an index of the “U” slot that is no longer valid within the traffic pattern, and/or the index of a “U” slot that will have an updated payload size within the traffic pattern. The UE may transmit the overriding report as a MAC-CE or in Li UCI, for example.

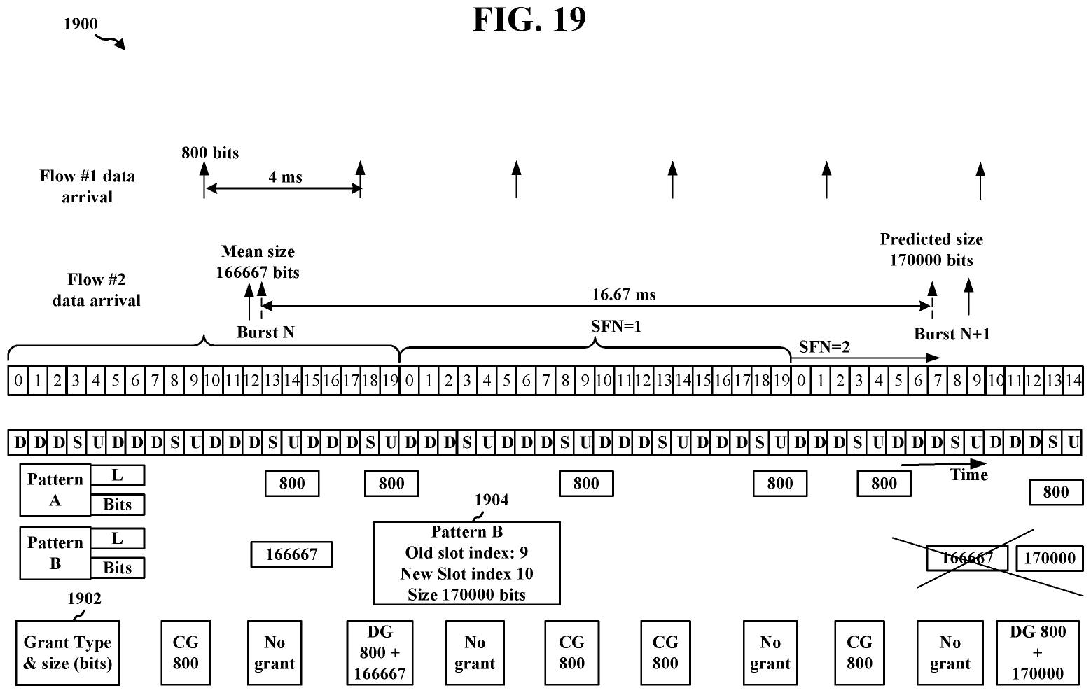

FIG. 19 illustrates an example resource diagram 1900 in which a UE may transmit an override report 1904 to a base station to adjust a previous semi-static indication (e.g., 1902) for resource allocation based on flow #2 being subject to jitter and a variation in payload size. The UE may report, or otherwise indicate, a semi-static pattern for resource allocation to the network. The resource allocation information may be based on mean arrival times (e.g., period) of data for a flow, and a mean payload size for the flow. The UE may continuously determine a predicted arrival time and size of a next data bust. At a particular data burst, e.g., burst N for flow #2, the UE may determine that a next data burst, e.g., bust N+1 of flow #2, will arrive later than the reported resource pattern and that the next data burst will have a larger payload size. With the data burst N, the UE may transmit an indication or report (e.g., an overriding report) to the network to cancel the “u” slot index 9 and the UE may provide a payload size for the “U” slot index 10. The network may skip allocation of resource for the “U” slot index 9 and may allocate resources for 800+170000 bits for ‘U’ slot index 10.

As described herein, the UE's indication of aggregation information and/or resource allocation information enables the network to provide more accurate resource allocations and may save overhead for SR, BSR, downlink signaling of dynamic grants, and/or PUSCH transmissions. In addition to the saved overhead, the aspects may help to reduce power consumption at the UE by enabling the UE to receive more accurate resource allocations prior to the arrival of data, which also reduces latency for the uplink data.

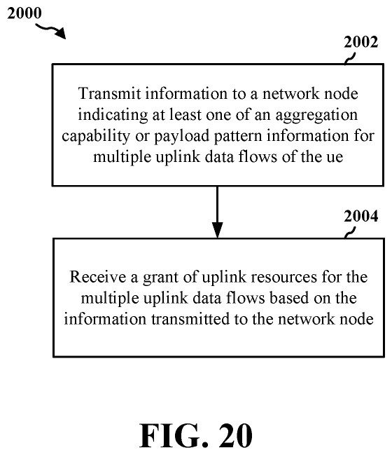

FIG. 20 is a flowchart 2000 of an example method of wireless communication. The method may be performed by a UE (e.g., the UE 104; 350; 704; the apparatus 2204). The method may be used to reduce latency for uplink transmission, reduce overhead, and/or help to reduce power consumption at a UE by enabling a network to provide a more accurate resource allocation based on information provided by the UE.

At 2002, the UE transmits information to a network node indicating at least one of an aggregation capability or payload pattern information for multiple uplink data flows of the UE. FIGS. 9-19 illustrate various examples of information that the UE may transmit to the network to assist in resource allocation to the UE. The information may be transmitted, e.g., by the UE information component 198. In some aspects, the information may indicate the aggregation capability to aggregate traffic of a first uplink data flow in a transmission occasion for a second uplink data flow. In some aspects, the information may indicate, for each uplink data flow, one or more of: timing information for uplink data, payload size information for the uplink data, variation of payload information for the uplink data, or jitter information. In some aspects, the information may indicate the payload size information, for at least one of the multiple uplink data flows, as an index referencing a table. In some aspects, the information may indicate the timing information based on at least one of: a period and a system time of a first data burst, or a bitmap associated with a configured grant pattern. In some aspects, the information may be included in at least one of: a radio resource control (RRC) message, a medium access control-control element (MAC-CE), or uplink control information (UCI). In some aspects, the indication is included in at least one of: a medium access control-control element (MAC-CE), or uplink control information (UCI).

In some aspects, the information may include the payload pattern information for the multiple uplink data flows of the UE. In some aspects, the payload pattern information may indicate a pattern of combined payload sizes in transmission occasions for an aggregation of the multiple uplink data flows. In some aspects, the payload pattern information may indicate a resource allocation pattern for each of the multiple uplink data flows, wherein each resource allocation pattern includes at least one of: a period, a payload size, an indication of traffic occurrences.

At 2004, the UE receives a grant of uplink resources for the multiple uplink data flows based on the information transmitted to the network node. The grant may be received, e.g., by the UE information component 198. FIGS. 8, 9, 10, 13, 15, and 19 illustrate various examples of a network node providing a grant of uplink resources based on information from the UE.

In some aspects, the grant of the uplink resources may include a configured grant for a first uplink data flow and a dynamic grant based on the aggregation capability for a second uplink data flow.

In some aspects, the grant of the uplink resources may include a configured grant with multiple payload sizes, including a first transport block size (TBS) for a first uplink data flow and a second TBS or multiple secondary TBSs (e.g., at least one secondary TBS) for an aggregation of a second uplink data flow with the first uplink data flow. In some aspects, the configured grant occasions having the second TBS may be indicated based on at least one of: a period and a system time of a first configured grant occasion, or a bitmap associated with a configured grant pattern.

In some aspects, the UE may transmit an indication of an information change for at least one occasion of the multiple uplink data flows. For example, FIG. 19 illustrate an example of an override report that a UE may provide to a network. In some aspects, the indication of the information change may indicate at least one index for a slot of a reported traffic pattern that is no longer valid or with an updated payload size.

In some aspects, the UE may transmit uplink data for the multiple uplink data flows in the uplink resources of the grant. For example, FIGS. 9, 10, 13, and 15 illustrate various examples of a UE transmitting uplink data based on granted resources.

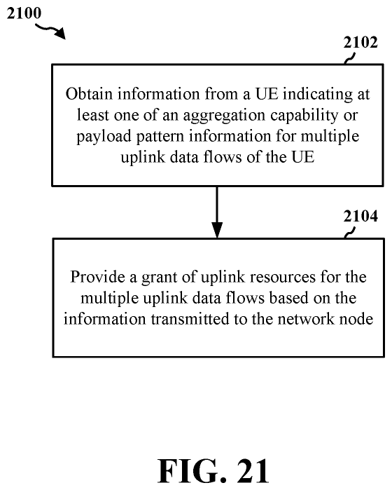

FIG. 21 is a flowchart 2100 of a method of wireless communication. The method may be performed by a network node or network entity (e.g., the base station 102, 310, 702; the CU 110, the DU 130, the RU; the network entity, 2302). The method may to reduce latency for uplink transmission, reduce overhead, and/or help to reduce power consumption at a UE by enabling a network to provide a more accurate resource allocation based on information received from the UE.

At 2102, the network node obtains information from a UE, the information indicating at least one of an aggregation capability or payload pattern information for multiple uplink data flows of the UE. FIGS. 9-19 illustrate various examples of a network receiving information from the UE to assist in resource allocation to the UE. The information may be obtained, e.g., by the uplink allocation component 199, for example. In some aspects, the information may indicate the aggregation capability to aggregate traffic of a first uplink data flow in a transmission occasion for a second uplink data flow. In some aspects, the information may indicate, for each uplink data flow, one or more of: timing information for uplink data, payload size information for the uplink data, variation of payload information for the uplink data, or jitter information. In some aspects, the information may indicate the payload size information, for at least one of the multiple uplink data flows, as an index referencing a table. In some aspects, the information may indicate the timing information based on at least one of: a period and a system time of a first data burst, or a bitmap associated with a configured grant pattern. In some aspects, the information may be included in at least one of: a radio resource control (RRC) message, a medium access control-control element (MAC-CE), or uplink control information (UCI). In some aspects, the indication is included in at least one of: a medium access control-control element (MAC-CE), or uplink control information (UCI).

In some aspects, the information may include the payload pattern information for the multiple uplink data flows of the UE. In some aspects, the payload pattern information may indicate a pattern of combined payload sizes in transmission occasions for an aggregation of the multiple uplink data flows. In some aspects, the payload pattern information may indicate a resource allocation pattern for each of the multiple uplink data flows, wherein each resource allocation pattern includes at least one of: a period, a payload size, an indication of traffic occurrences.

At 2104, the network node provides a grant of uplink resources for the multiple uplink data flows based on the information transmitted to the network node. The grant may be provided, e.g., by the uplink allocation component 199. In some aspects, the grant of the uplink resources may include a configured grant for a first uplink data flow and a dynamic grant based on the aggregation capability for a second uplink data flow. In some aspects, the techniques described herein relate to a method, wherein the grant of the uplink resources includes a configured grant with multiple payload sizes, including a first transport block size (TBS) for a first uplink data flow and at least one secondary TBS for an aggregation of a second uplink data flow with the first uplink data flow.

In some aspects, the network node may receive an additional indication of an information change for at least one occasion of the multiple uplink data flows, wherein the additional indication of the information change indicates at least one index for a slot of a reported traffic pattern that is no longer valid or with an updated payload size. In some aspects, the additional indication may be included in at least one of: a medium access control-control element (MAC-CE), or uplink control information (UCI).

In some aspects, the network node may receive uplink data for the multiple uplink data flows in the uplink resources of the grant.

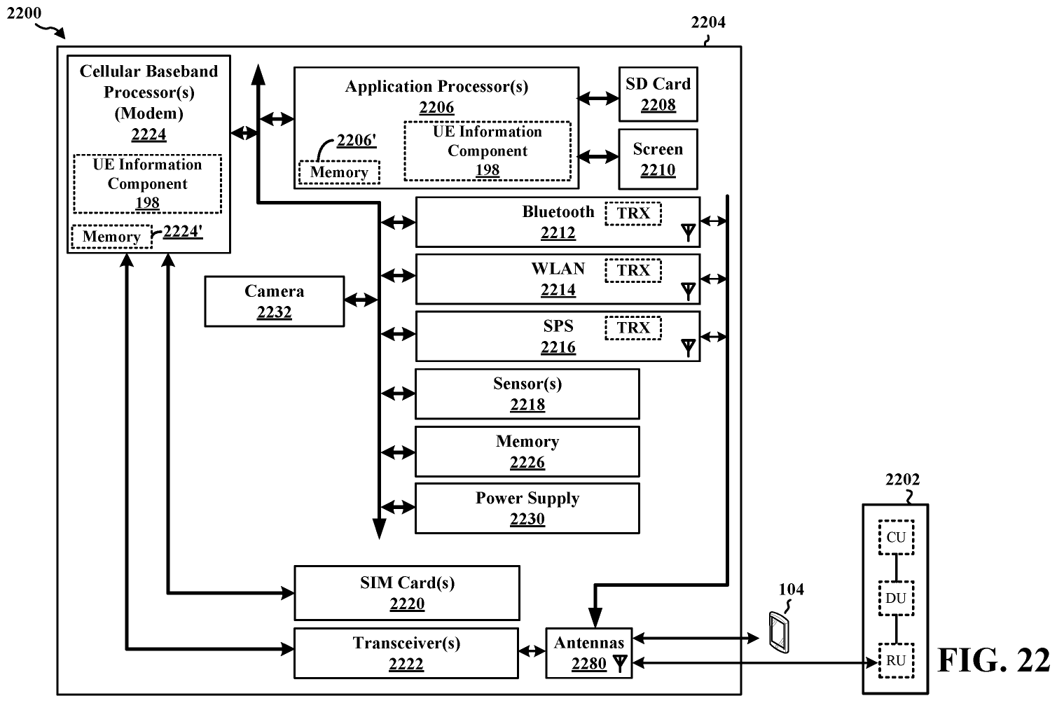

FIG. 22 is a diagram 2200 illustrating an example of a hardware implementation for an apparatus 2204. The apparatus 2204 may be a UE, a component of a UE, or may implement UE functionality. In some aspects, the apparatus2204 may include at least one cellular baseband processor 2224 (also referred to as a modem) coupled to one or more transceivers 2222 (e.g., cellular RF transceiver). The cellular baseband processor(s) 2224 may include at least one on-chip memory 2224′. In some aspects, the apparatus 2204 may further include one or more subscriber identity modules (SIM) cards 2220 and at least one application processor 2206 coupled to a secure digital (SD) card 2208 and a screen 2210. The application processor(s) 2206 may include on-chip memory 2206′. In some aspects, the apparatus 2204 may further include a Bluetooth module 2212, a WLAN module 2214, an SPS module 2216 (e.g., GNSS module), one or more sensor modules 2218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2226, a power supply 2230, and/or a camera 2232. The Bluetooth module 2212, the WLAN module 2214, and the SPS module 2216 may include an on-chip transceiver (TRX) (or in some cases, just a receiver (RX)). The Bluetooth module 2212, the WLAN module 2214, and the SPS module 2216 may include their own dedicated antennas and/or utilize the antennas 2280 for communication. The cellular baseband processor(s) 2224 communicates through the transceiver(s) 2222 via one or more antennas 2280 with the UE 104 and/or with an RU associated with a network entity 2202. The cellular baseband processor(s) 2224 and the application processor(s) 2206 may each include a computer-readable medium/memory 2224′, 2206′, respectively. The additional memory modules 2226 may also be considered a computer-readable medium/memory. Each computer-readable medium/memory 2224′, 2206′, 2226 may be non-transitory. The cellular baseband processor(s) 2224 and the application processor(s) 2206 are each responsible for general processing, including the execution of software stored on the computer-readable medium/memory. The software, when executed by the cellular baseband processor(s) 2224/application processor(s) 2206, causes the cellular baseband processor(s) 2224/application processor(s) 2206 to perform the various functions described supra. The cellular baseband processor(s) 2224 and the application processor(s) 2206 are configured to perform the various functions described supra based at least in part of the information stored in the memory. That is, the cellular baseband processor(s) 2224 and the application processor(s) 2206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 2224/application processor(s) 2206 when executing software. The cellular baseband processor(s) 2224/application processor(s) 2206 may be a component of the UE 350 and may include the at least one memory 360 and/or at least one of the TX processor 368, the RX processor 356, and the controller/processor 359. In one configuration, the apparatus 2204 may be at least one processor chip (modem and/or application) and include just the cellular baseband processor(s) 2224 and/or the application processor(s) 2206, and in another configuration, the apparatus 2204 may be the entire UE (e.g., see UE 350 of FIG. 3) and include the additional modules of the apparatus 2204.

As discussed supra, the component 198 may be configured to transmit information to a network node indicating at least one of an aggregation capability or payload pattern information for multiple uplink data flows of the UE; and receive a grant of uplink resources for the multiple uplink data flows based on the information transmitted to the network node. The component 198 may be further configured to transmit an indication of an information change for at least one occasion of the multiple uplink data flows. The component 198 may be further configured to transmit uplink data for the multiple uplink data flows in the uplink resources of the grant. The component 199 may be further configured to perform any of the aspects described in connection with the flowchart in FIG. 20, and/or the aspects performed by the UE in any of FIGS. 5-19. The component 198 may be within the cellular baseband processor(s) 2224, the application processor(s) 2206, or both the cellular baseband processor(s) 2224 and the application processor(s) 2206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2204 may include a variety of components configured for various functions. In one configuration, the apparatus 2204, and in particular the cellular baseband processor(s) 2224 and/or the application processor(s) 2206, may include means for transmitting information to a network node indicating at least one of an aggregation capability or payload pattern information for multiple uplink data flows of the UE; and means for receiving a grant of uplink resources for the multiple uplink data flows based on the information transmitted to the network node. The apparatus may further include means for transmitting an indication of an information change for at least one occasion of the multiple uplink data flows. The apparatus may further include means for transmitting uplink data for the multiple uplink data flows in the uplink resources of the grant. The apparatus may further include means for performing any of the aspects described in connection with the flowchart in FIG. 20, and/or the aspects performed by the UE in any of FIGS. 5-19. The means may be the component 198 of the apparatus 2204 configured to perform the functions recited by the means. As described supra, the apparatus 2204 may include the TX processor 368, the RX processor 356, and the controller/processor 359. As such, in one configuration, the means may be the TX processor 368, the RX processor 356, and/or the controller/processor 359 configured to perform the functions recited by the means.

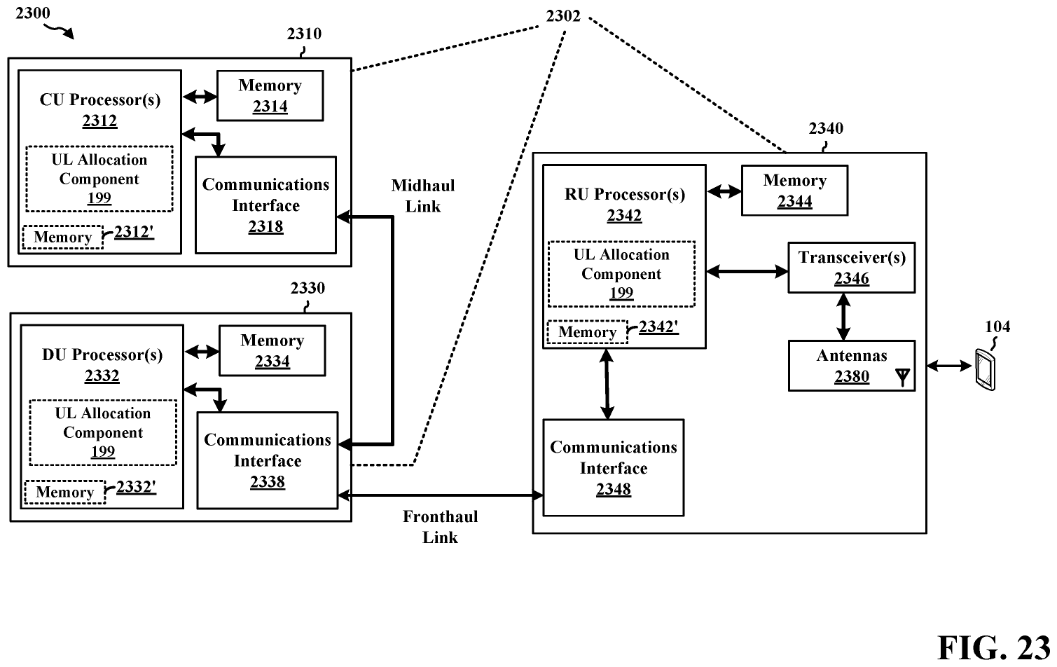

FIG. 23 is a diagram 2300 illustrating an example of a hardware implementation for a network entity 2302 or network node. The network entity 2302 may be a BS, a component of a BS, or may implement BS functionality. The network entity 2302 may include at least one of a CU 2310, a DU 2330, or an RU 2340. For example, depending on the layer functionality handled by the component 199, the network entity 2302 may include the CU 2310; both the CU 2310 and the DU 2330; each of the CU 2310, the DU 2330, and the RU 2340; the DU 2330; both the DU 2330 and the RU 2340; or the RU 2340. The CU 2310 may include at least one CU processor 2312. The CU processor(s) 2312 may include on-chip memory 2312′. In some aspects, the CU 2310 may further include additional memory modules 2314 and a communications interface 2318. The CU 2310 communicates with the DU 2330 through a midhaul link, such as an F1 interface. The DU 2330 may include at least one DU processor 2332. The DU processor(s) 2332 may include on-chip memory 2332′. In some aspects, the DU 2330 may further include additional memory modules 2334 and a communications interface 2338. The DU 2330 communicates with the RU 2340 through a fronthaul link. The RU 2340 may include at least one RU processor 2342. The RU processor(s) 2342 may include on-chip memory 2342′. In some aspects, the RU 2340 may further include additional memory modules 2344, one or more transceivers 2346, antennas 2380, and a communications interface 2348. The RU 2340 communicates with the UE 104. The on-chip memory 2312′, 2332′, 2342′ and the additional memory modules 2314, 2334, 2344 may each be considered a computer-readable medium/memory. Each computer-readable medium/memory may be non-transitory. Each of the processors 2312, 2332, 2342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to obtain information from a user equipment (UE), the information indicating at least one of an aggregation capability or payload pattern information for multiple uplink data flows of the UE; and provide a grant of uplink resources for the multiple uplink data flows based on the information transmitted to the network node. The component 199 may be further configured to receive an additional indication of an information change for at least one occasion of the multiple uplink data flows, wherein the additional indication of the information change indicates at least one index for a slot of a reported traffic pattern that is no longer valid or with an updated payload size. The component 199 may be further configured to receive uplink data for the multiple uplink data flows in the uplink resources of the grant. The component 199 may be further configured to perform any of the aspects described in connection with the flowchart in FIG. 21, and/or the aspects performed by the network in any of FIGS. 5-19. The component 199 may be within one or more processors of one or more of the CU 2310, DU 2330, and the RU 2340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2302 may include a variety of components configured for various functions. In one configuration, the network entity 2302 may include means for obtaining information from a user equipment (UE), the information indicating at least one of an aggregation capability or payload pattern information for multiple uplink data flows of the UE; and means for providing a grant of uplink resources for the multiple uplink data flows based on the information transmitted to the network node. The apparatus may further include means for receiving an additional indication of an information change for at least one occasion of the multiple uplink data flows, wherein the additional indication of the information change indicates at least one index for a slot of a reported traffic pattern that is no longer valid or with an updated payload size. The apparatus may further include means for receiving uplink data for the multiple uplink data flows in the uplink resources of the grant. The apparatus may further include means for performing any of the aspects described in connection with the flowchart in FIG. 21, and/or the aspects performed by the network in any of FIGS. 5-19. The means may be the component 199 of the network entity 2302 configured to perform the functions recited by the means. As described supra, the network entity 2302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: transmitting information to a network node indicating at least one of an aggregation capability or payload pattern information for multiple uplink data flows of the UE; and receiving a grant of uplink resources for the multiple uplink data flows based on the information transmitted to the network node.

In aspect 2, the method of aspect 1 further includes that the information indicates the aggregation capability to aggregate traffic of a first uplink data flow in a transmission occasion for a second uplink data flow.

In aspect 3, the method of aspect 1 or 2 further includes that the information indicates, for each uplink data flow, one or more of: timing information for uplink data, payload size information for the uplink data, variation of payload information for the uplink data, or jitter information.

In aspect 4, the method of aspect 3 further includes that the information indicates the payload size information, for at least one of the multiple uplink data flows, as an index referencing a table.

In aspect 5, the method of aspect 3 further includes that the information indicates the timing information based on at least one of: a period and a system time of a first data burst, or a bitmap associated with a configured grant pattern.

In aspect 6, the method of any of aspects 1-5 further includes that the information is comprised in at least one of: an RRC message, a MAC-CE, or UCI.

In aspect 7, the method of any of aspects 1-6 further includes that the grant of the uplink resources includes a configured grant for a first uplink data flow and a dynamic grant based on the aggregation capability for a second uplink data flow.

In aspect 8, the method of any of aspects 1-6 further includes that the grant of the uplink resources includes a configured grant with multiple payload sizes, including a first TBS for a first uplink data flow and at least one secondary TBS for an aggregation of a second uplink data flow with the first uplink data flow.

In aspect 9, the method of aspect 8 further includes that configured grant occasions having a secondary TBS of the at least one secondary TBS are indicated based on at least one of: a period and a system time of a first configured grant occasion, or a bitmap associated with a configured grant pattern.

In aspect 10, the method of any of aspects 1-9 further includes that the information includes the payload pattern information for the multiple uplink data flows of the UE.

In aspect 11, the method of aspect 10 further includes that the payload pattern information indicates a pattern of combined payload sizes in transmission occasions for an aggregation of the multiple uplink data flows.

In aspect 12, the method of aspect 10 further includes that the payload pattern information indicates a resource allocation pattern for each of the multiple uplink data flows, wherein each resource allocation pattern includes at least one of: a period, a payload size, or a traffic occurrence indication of one or more traffic occurrences.

In aspect 13, the method of aspect 10 further includes transmitting an indication of an information change for at least one occasion of the multiple uplink data flows.

In aspect 14, the method of aspect 13 further includes that the indication of the information change indicates at least one index for a slot of a reported traffic pattern that is no longer valid or with an updated payload size.

In aspect 15, the method of aspect 13 or 14 further includes that the indication is comprised in at least one of: a MAC-CE, or UCI.

In aspect 16, the method of any of aspects 1-15 further includes transmitting uplink data for the multiple uplink data flows in the uplink resources of the grant.

Aspect 17 is an apparatus for wireless communication at a UE, comprising: at least one memory; and at least one processor coupled to the at least one memory and, based at least in part on information stored in the at least one memory, the at least one processor, individually or in any combination, is configured to cause the UE to perform the method of any of aspects 1-16.

Aspect 18 is an apparatus for wireless communication at a UE, comprising: at least one memory; and at least one processor coupled to the at least one memory and, individually or in any combination, is configured to cause the UE to perform the method of any of aspects 1-16.

Aspect 19 is an apparatus for wireless communication at a UE, comprising: one or more memories; and one or more processors coupled to the one or more memories and, based at least in part on information stored in the one or more memories, the one or more processors, individually or in any combination, are configured to cause the UE to perform the method of any of aspects 1-16.

Aspect 20 is an apparatus for wireless communication at a UE, comprising means for performing each step in the method of any of aspects 1-16.

Aspect 21 is the apparatus of any of aspects 17-20, further comprising a transceiver configured to receive or to transmit in association with the method of any of aspects 1-16.

Aspect 22 is a computer-readable medium storing computer executable code at a UE, the code when executed by at least one processor causes the UE to perform the method of any of aspects 1-16.

Aspect 23 is a method of wireless communication at a network node, comprising: obtaining information from a UE, the information indicating at least one of an aggregation capability or payload pattern information for multiple uplink data flows of the UE; and providing a grant of uplink resources for the multiple uplink data flows based on the information transmitted to the network node.

In aspect 24, the method of aspect 23 further includes that the information indicates the aggregation capability to aggregate traffic of a first uplink data flow in a transmission occasion for a second uplink data flow, wherein the information indicates, for each uplink data flow, one or more of: timing information for uplink data, payload size information for the uplink data, variation of payload information for the uplink data, or jitter information.

In aspect 25, the method of aspect 23 or 24 further includes that the information is comprised in at least one of: an RRC message, a MAC-CE, or UCI.

In aspect 26, the method of any of aspects 23-25 further includes that the grant of the uplink resources includes a configured grant for a first uplink data flow and a dynamic grant based on the aggregation capability for a second uplink data flow.

In aspect 27, the method of any of aspects 23-25 further includes that the grant of the uplink resources includes a configured grant with multiple payload sizes, including a first TBS for a first uplink data flow and at least one secondary TBS for an aggregation of a second uplink data flow with the first uplink data flow.

In aspect 28, the method of any of aspects 23-27 further includes that the information includes the payload pattern information for the multiple uplink data flows of the UE, wherein the payload pattern information indicates at least one of: a pattern of combined payload sizes in transmission occasions for an aggregation of the multiple uplink data flows, or a resource allocation pattern for each of the multiple uplink data flows, wherein each resource allocation pattern includes at least one of a period, a payload size, or a traffic occurrence indication of one or more traffic occurrences.

In aspect 29, the method of aspect 28 further includes receiving an additional indication of an information change for at least one occasion of the multiple uplink data flows, wherein the additional indication of the information change indicates at least one index for a slot of a reported traffic pattern that is no longer valid or with an updated payload size.

In aspect 30, the method of aspect 28 or 29 further includes that the additional indication is comprised in at least one of: a MAC-CE or UCI.

In aspect 31, the method of any of aspects 23-29 further includes receiving uplink data for the multiple uplink data flows in the uplink resources of the grant.

Aspect 32 is an apparatus for wireless communication at a network node, comprising: at least one memory; and at least one processor coupled to the at least one memory and, based at least in part on information stored in the at least one memory, the at least one processor, individually or in any combination, is configured to cause the network node to perform the method of any of aspects 23-31.

Aspect 33 is an apparatus for wireless communication at a network node, comprising: at least one memory; and at least one processor coupled to the at least one memory and, individually or in any combination, is configured to cause the network node to perform the method of any of aspects 23-31.

Aspect 34 is an apparatus for wireless communication at a network node, comprising: one or more memories; and one or more processors coupled to the one or more memories and, based at least in part on information stored in the one or more memories, the one or more processors, individually or in any combination, are configured to cause the network node to perform the method of any of aspects 23-31.

Aspect 35 is an apparatus for wireless communication at a network node, comprising means for performing each step in the method of any of aspects 23-31.

Aspect 36 is the apparatus of any of aspects 32-35, further comprising a transceiver configured to receive or to transmit in association with the method of any of aspects 23-31.

Aspect 37 is a computer-readable medium storing computer executable code at a network node, the code when executed by at least one processor causes the network node to perform the method of any of aspects 23-31.

What is claimed is:

1. An apparatus for wireless communication at a user equipment (UE), comprising:
at least one memory; and
at least one processor coupled to the at least one memory and, based at least in part on stored information that stored in the at least one memory, the at least one processor, individually or in any combination, is configured to cause the UE to:
transmit information to a network node indicating at least one of an aggregation capability or payload pattern information for multiple uplink data flows of the UE; and
receive a grant of uplink resources for the multiple uplink data flows based on the information transmitted to the network node.

2. The apparatus of claim 1, wherein the information indicates the aggregation capability to aggregate traffic of a first uplink data flow in a transmission occasion for a second uplink data flow, wherein the information indicates, for each uplink data flow, one or more of:
timing information for uplink data,
payload size information for the uplink data,
variation of payload information for the uplink data, or
jitter information.

3. The apparatus of claim 2, wherein the information indicates the payload size information, for at least one of the multiple uplink data flows, as an index referencing a table.

4. The apparatus of claim 2, wherein the information indicates the timing information based on at least one of:
a period and a system time of a first data burst, or
a bitmap associated with a configured grant pattern.

5. The apparatus of claim 2, wherein the information is comprised in at least one of:
a radio resource control (RRC) message,
a medium access control-control element (MAC-CE), or
uplink control information (UCI).

6. The apparatus of claim 1, wherein the grant of the uplink resources includes a configured grant for a first uplink data flow and a dynamic grant based on the aggregation capability for a second uplink data flow.

7. The apparatus of claim 1, wherein the grant of the uplink resources includes a configured grant with multiple payload sizes, including a first transport block size (TBS) for a first uplink data flow and at least one secondary TBS for an aggregation of a second uplink data flow with the first uplink data flow.

8. The apparatus of claim 7, wherein configured grant occasions having a secondary TBS of the at least one secondary TBS are indicated based on at least one of:
a period and a system time of a first configured grant occasion, or
a bitmap associated with a configured grant pattern.

9. The apparatus of claim 1, wherein the information includes the payload pattern information for the multiple uplink data flows of the UE, wherein the payload pattern information indicates a pattern of combined payload sizes in transmission occasions for an aggregation of the multiple uplink data flows, or wherein the payload pattern information indicates a resource allocation pattern for each of the multiple uplink data flows, wherein each resource allocation pattern includes at least one of:
a period,
a payload size, or
a traffic occurrence indication of one or more traffic occurrences.

10. The apparatus of claim 9, wherein the at least one processor is further configured to cause the UE to:
transmit an indication of an information change for at least one occasion of the multiple uplink data flows.

11. The apparatus of claim 10, wherein the indication of the information change indicates at least one index for a slot of a reported traffic pattern that is no longer valid or with an updated payload size, and wherein the indication is comprised in at least one of:
a medium access control-control element (MAC-CE), or
uplink control information (UCI).

12. The apparatus of claim 1, wherein the at least one processor is further configured to cause the UE to:
transmit uplink data for the multiple uplink data flows in the uplink resources of the grant.

13. An apparatus for wireless communication at a network node, comprising:
at least one memory; and
at least one processor coupled to the at least one memory and, based at least in part on stored information that is stored in the at least one memory, the at least one processor, individually or in any combination, is configured to cause the network node to:
obtain information from a user equipment (UE), the information indicating at least one of an aggregation capability or payload pattern information for multiple uplink data flows of the UE; and
provide a grant of uplink resources for the multiple uplink data flows based on the information transmitted to the network node.

14. The apparatus of claim 13, wherein the information indicates the aggregation capability to aggregate traffic of a first uplink data flow in a transmission occasion for a second uplink data flow, wherein the information indicates, for each uplink data flow, one or more of: timing information for uplink data, payload size information for the uplink data, variation of payload information for the uplink data, or jitter information, and wherein the information is comprised in at least one of:
a radio resource control (RRC) message,
a medium access control-control element (MAC-CE), or
uplink control information (UCI).

15. The apparatus of claim 13, wherein the grant of the uplink resources includes a configured grant for a first uplink data flow and a dynamic grant based on the aggregation capability for a second uplink data flow.

16. The apparatus of claim 13, wherein the grant of the uplink resources includes a configured grant with multiple payload sizes, including a first transport block size (TBS) for a first uplink data flow and at least one secondary TBS for an aggregation of a second uplink data flow with the first uplink data flow.

17. The apparatus of claim 13, wherein the information includes the payload pattern information for the multiple uplink data flows of the UE, wherein the payload pattern information indicates at least one of:
a pattern of combined payload sizes in transmission occasions for an aggregation of the multiple uplink data flows, or
a resource allocation pattern for each of the multiple uplink data flows, wherein each resource allocation pattern includes at least one of a period, a payload size, or an indication of traffic occurrences, and wherein the at least one processor is further configured to cause the network node to:
receive an additional indication of an information change for at least one occasion of the multiple uplink data flows, wherein the additional indication of the information change indicates at least one index for a slot of a reported traffic pattern that is no longer valid or with an updated payload size.

18. The apparatus of claim 13, wherein the at least one processor is further configured to cause the network node to:
receive uplink data for the multiple uplink data flows in the uplink resources of the grant.

19. A method of wireless communication at a user equipment (UE), comprising:
transmitting information to a network node indicating at least one of an aggregation capability or payload pattern information for multiple uplink data flows of the UE; and
receiving a grant of uplink resources for the multiple uplink data flows based on the information transmitted to the network node.

20. The method of claim 19, wherein the information indicates the aggregation capability to aggregate traffic of a first uplink data flow in a transmission occasion for a second uplink data flow, and, wherein the information indicates, for each uplink data flow, one or more of:
timing information for uplink data,
payload size information for the uplink data,
variation of payload information for the uplink data, or
jitter information.

21. The method of claim 20, wherein the information indicates the payload size information, for at least one of the multiple uplink data flows, as an index referencing a table, or wherein the information indicates the timing information based on at least one of:
a period and a system time of a first data burst, or
a bitmap associated with a configured grant pattern.

22. The method of claim 19, wherein the grant of the uplink resources includes a first configured grant for a first uplink data flow and a dynamic grant based on the aggregation capability for a second uplink data flow, or wherein the grant of the uplink resources includes a second configured grant with multiple payload sizes, including a first transport block size (TBS) for the first uplink data flow and at least one secondary TBS for an aggregation of the second uplink data flow with the first uplink data flow.

23. The method of claim 19, wherein the information includes the payload pattern information for the multiple uplink data flows of the UE.

24. The method of claim 23, wherein the payload pattern information indicates a pattern of combined payload sizes in transmission occasions for an aggregation of the multiple uplink data flows, or wherein the payload pattern information indicates a resource allocation pattern for each of the multiple uplink data flows, wherein each resource allocation pattern includes at least one of:
a period,
a payload size, or
an indication of traffic occurrences.

25. The method of claim 23, further comprising:
transmitting an indication of an information change for at least one occasion of the multiple uplink data flows, wherein the indication of the information change indicates at least one index for a slot of a reported traffic pattern that is no longer valid or with an updated payload size.

26. The method of claim 25, wherein the indication is comprised in at least one of:
a medium access control-control element (MAC-CE), or
uplink control information (UCI).

27. The method of claim 19, further comprising:
transmitting uplink data for the multiple uplink data flows in the uplink resources of the grant.

28. A method of wireless communication at a network node, comprising:
obtaining information from a user equipment (UE), the information indicating at least one of an aggregation capability or payload pattern information for multiple uplink data flows of the UE; and
providing a grant of uplink resources for the multiple uplink data flows based on the information transmitted to the network node.

29. The method of claim 28, wherein the information indicates the aggregation capability to aggregate traffic of a first uplink data flow in a transmission occasion for a second uplink data flow, wherein the information indicates, for each uplink data flow, one or more of: timing information for uplink data, payload size information for the uplink data, variation of payload information for the uplink data, or jitter information, and wherein the information is comprised in at least one of:
a radio resource control (RRC) message,
a medium access control-control element (MAC-CE), or
uplink control information (UCI).

30. The method of claim 28, wherein the information includes the payload pattern information for the multiple uplink data flows of the UE, wherein the payload pattern information indicates at least one of:
a pattern of combined payload sizes in transmission occasions for an aggregation of the multiple uplink data flows, or
a resource allocation pattern for each of the multiple uplink data flows, wherein each resource allocation pattern includes at least one of a period, a payload size, or an indication of traffic occurrences, and the method further comprising:
receiving an additional indication of an information change for at least one occasion of the multiple uplink data flows, wherein the additional indication of the information change indicates at least one index for a slot of a reported traffic pattern that is no longer valid or with an updated payload size.
